(19) United States
(12) Patent Application Publication
(10) Pub. No.: US 2009/0295853 A1
(43) Pub. Date: Dec. 3, 2009

(54) FLUID EJECTING APPARATUS

(75) Inventors: Satoru Hosono, Azumino-shi (JP); Sayuri Kawakami, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/475,396

(22) Filed: May 29, 2009

(30) Foreign Application Priority Data
May 30, 2008 (JP) 2008-143690
Feb. 19, 2009 (JP) 2009-036416

(51) Int. Cl. B41J 29/38

(52) U.S. Cl. 347/10

(57) ABSTRACT

A fluid ejecting apparatus that ejects fluid includes: a pressure chamber that is filled with the fluid; a pressure generating element that deforms a wall face of the pressure chamber to change a volume of the pressure chamber; a nozzle that is in fluid communication with the pressure chamber and that is used for ejecting the fluid; and a control unit that generates a drive pulse for controlling the pressure generating element. The control unit is able to generate a maintenance drive pulse for ejecting a bubble together with the fluid from the pressure chamber. The maintenance drive pulse includes a first pulse portion that drives the pressure generating element to cause the pressure chamber to expand into an expanded state and a second pulse portion that causes the pressure chamber to contract from the expanded state. The width of the second pulse portion is equal to or smaller than half the Helmholtz resonance period of the fluid with which the pressure chamber is filled.

This application claims priority to Japanese Patent Application No. 2008-143690, filed May 30, 2008 and to Japanese Patent Application No. 2009-036416, filed Feb. 19, 2009. The entire disclosures of the aforementioned applications are incorporated herein by reference.

### BACKGROUND

1. Technical Field

The present invention relates to a fluid ejecting apparatus that ejects fluid from a nozzle.

2. Related Art

An ink jet printer performs printing by discharging (ejecting) ink droplets from nozzles toward a sheet face. In the ink jet printer, because of thickened ink adhered to nozzle openings due to natural evaporation or absorption of pressure change in ink chambers by bubbles trapped in the ink chambers that are filled with ink, poor discharge of ink droplets may occur.

In order to keep favorable discharge of ink droplets, various techniques for a maintenance process have been suggested, which are, for example, described in JP-A-2007-136989, JP-A-59-131464. For example, in JP-A-2007-136989, a negative pressure is generated by a pump with nozzles temporarily sealed with a cap, and a pressure is applied to ink chambers using pressure generating elements to idly discharge ink droplets, thus performing removal of thickened ink and bubbles.

However, even when the above maintenance process has been performed, a sufficient force, such as pressure, for draining bubbles cannot be applied for micro-diameter bubbles (for example, bubbles having a diameter of several tens of micrometers), so that it is difficult to completely remove bubbles. The above problem not only applies to an ink jet printer but also applies to a fluid ejecting apparatus that ejects fluid other than ink (including liquid and liquid body formed of dispersed particles of a functional material). The above problem has not been addressed sufficiently.

### SUMMARY

An advantage of some aspects of the invention is that it provides a technique for removing bubbles that cause poor ejection in nozzles of a fluid ejecting apparatus that ejects fluid.

A fluid ejecting apparatus that ejects fluid includes: a pressure chamber that is filled with the fluid; a pressure generating element that deforms a wall face of the pressure chamber to change a volume of the pressure chamber; a nozzle that is in fluid communication with the pressure chamber and that is used for ejecting the fluid; and a control unit that generates a drive pulse for controlling the pressure generating element. The control unit is able to generate a maintenance drive pulse for ejecting a bubble together with the fluid from the pressure chamber. The maintenance drive pulse includes a first pulse portion that drives the pressure generating element to cause the pressure chamber to expand into an expanded state and a second pulse portion that causes the pressure chamber to contract from the expanded state. The width of the second pulse portion is equal to or smaller than half the Helmholtz resonance period of the fluid with which the pressure chamber is filled. According to the above fluid ejecting apparatus, at the time of flushing, a pressure applied to fluid in the pressure chamber by the pressure generating element may be further increased using Helmholtz resonance. Then, it is possible to further increase a force, As a result of a pressure wave, that acts on fluid in the pressure chamber to further increase the speed at which a bubble disappears, while making it possible to discharge the bubble with the fluid. Thus, it is possible to reliably remove a bubble, which causes poor ejection in a nozzle, in the pressure chamber. Note that in the specification, the real numbers shown to the first decimal place have set one significant digit and are rounded off to the first decimal place.

In the fluid ejecting apparatus according to an embodiment of the invention, the width of the second pulse portion is equal to or larger than half the natural vibration period of the pressure generating element. According to the above fluid ejecting apparatus, a pressure may be applied to the fluid in the pressure chamber as it is resonated with the natural vibration of the pressure generating element. Thus, it is possible to further reliably remove a bubble in the pressure chamber.

In the fluid ejecting apparatus according to another embodiment of the invention, the maintenance drive pulse further includes an intermediate pulse portion between the first and second pulse portions, wherein the intermediate pulse portion holds the expanded state of the pressure chamber for a predetermined period of time, and the width of the intermediate pulse portion is equal to or larger than 0.7 times the Helmholtz resonance period of the fluid. According to the above fluid ejecting apparatus, the width of the intermediate pulse portion is adjusted in view of the Helmholtz resonance period of the fluid in the pressure chamber in order to make it possible to apply a pressure to the fluid in the pressure chamber by the second pulse portion at a timing at which a further large pressure may be generated. Thus, it is possible to further reliably remove a bubble in the pressure chamber.

In the fluid ejecting apparatus according to another embodiment of the invention, the width of the intermediate pulse portion is equal to or shorter than the Helmholtz resonance period of the fluid. According to the above fluid ejecting apparatus, it is possible to improve the nozzle recovery rate and also possible to improve the flight stability of discharged fluid. Thus, it is possible to suppress an increase in the amount of fluid consumed in discharging for nozzle recovery.

In the fluid ejecting apparatus according to another embodiment of the invention, the fluid ejecting apparatus ejects ink as the fluid. According to the above fluid ejecting apparatus, even when a bubble is generated in ink inside the pressure chamber, the bubble may be easily removed. Thus, it is possible to suppress occurrence of dot omission or ink clogging.

Note that the aspects of the invention may be implemented in various forms. For example, the aspects of the invention may be implemented in a form, such as a maintenance method against nozzle clogging in a fluid ejecting apparatus, a fluid ejecting apparatus that implements the maintenance method, and an ink jet printer that provides those methods or apparatuses.

### BRIEF DESCRIPTION OF THE DRAWINGS

The invention will be described with reference to the accompanying drawings, wherein like numbers reference like elements.

FIG. 1 is a schematic view that shows a configuration of an ink jet printer according to an embodiment.

FIG. 2A and FIG. 2B are schematic cross-sectional views that show the configuration of a print head unit.

FIG. 3 is a schematic view that shows the electrical configuration of the print head unit.

FIG. 4 is a schematic cross-sectional view that shows the configuration of the print head unit and a cap unit when maintenance process is performed.

FIG. 5 is a flowchart that shows the steps of bubble removal flushing.

FIG. 6 is a graph that shows a drive pulse generated by a control unit in the bubble removal flushing.

FIG. 7A to FIG. 7C are schematic views that illustrate the mechanism of removing a bubble in the bubble removal flushing.

FIG. 8A and FIG. 8B are a graph and a table of experimental results, illustrating a desirable width of a first pulse portion.

FIG. 9 is a graph that illustrates a difference in nozzle recovery rate against a width of a second pulse portion.

FIG. 10A and FIG. 10B are graphs that show a relationship between a width of the second pulse portion and a discharged ink droplet speed and a relationship between a width of the second pulse portion and an amount of ink discharged.

FIG. 11A is a graph that shows a relationship between a width of the second pulse portion and a discharged ink droplet speed and a relationship between a width of the second pulse portion and an amount of ink discharged, and FIG. 11B is a graph that shows a relationship between a width of the second pulse portion and a nozzle recovery rate.

FIG. 12A to FIG. 12C are tables that show an evaluation of recoverability of nozzles using a bubble removal drive pulse and an evaluation of flight stability of ink droplets in idle discharge of the nozzles.

FIG. 13A to FIG. 13C are images that show the states of landed ink droplets for evaluation of flight stability of ink droplets.

FIG. 14 is a schematic view that shows the configuration of an ink jet printer according to an embodiment.

FIG. 15 is a schematic cross-sectional view that shows the configuration of a print head unit, cap unit and wiper unit according to an embodiment.

FIG. 16 is a schematic view that illustrates a vacuum operation in which ink is vacuumed by the cap unit.

FIG. 17A and FIG. 17B are schematic views that illustrate a cleaning process in which a nozzle face is cleaned by the wiper unit.

FIG. 18 is a flowchart that shows the steps of initial filling process according to an embodiment.

FIG. 19 is a graph that shows a pressure change in a cap closed space when the initial filling process is being performed.

FIG. 20 is a graph that shows a drive pulse generated by the control unit in color mixture prevention flushing.

FIG. 21 is a schematic view that shows the configuration of an ink jet printer according to an embodiment.

FIG. 22 is a flowchart that shows the steps when printing is being performed by the ink jet printer according to an embodiment.

FIG. 23 is a flowchart that shows the steps of timer cleaning process according to an embodiment.

FIG. 24 is a graph that shows a pressure change in a cap closed space when the timer cleaning process is being performed.

FIG. 25 is a schematic view that shows the configuration of an ink jet printer according to an embodiment.

FIG. 26 is a flowchart that shows the steps of manual cleaning process.

FIG. 27 is a graph that shows a pressure change in a cap closed space when the manual cleaning process is being performed.

FIG. 28 is a flowchart that shows the steps when printing is being performed by an ink jet printer according to an embodiment.

### DESCRIPTION OF EXEMPLARY EMBODIMENTS

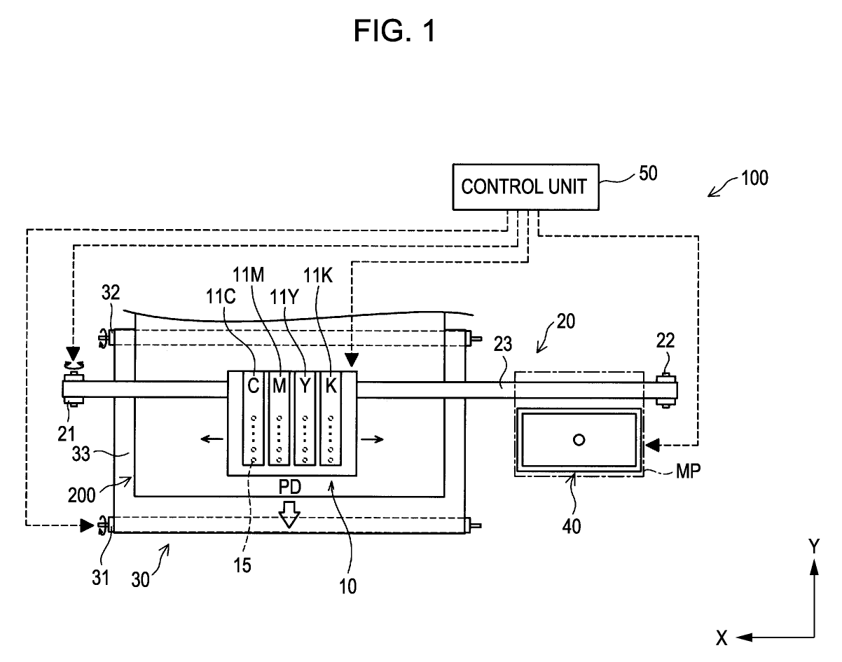

FIG. 1 is a schematic view that shows the configuration of an ink jet printer according to an embodiment of the invention. The ink jet printer 100 is an ink jet printing apparatus that forms an image by discharging ink droplets of a plurality of colors onto a sheet face in accordance with print data transmitted externally. The ink jet printer 100 includes a print head unit 10, a head driving unit 20, a paper transport unit 30, a cap unit 40, and a control unit 50.

The print head unit 10 has detachably mounted ink cartridges 11C, 11M, 11Y, and 11K of four colors consisting of cyan, yellow, magenta and black. When the ink jet printer 100 performs printing, the print head unit 10 repeats reciprocal movement in a vertical direction (arrow X direction in the drawing) with respect to a transport direction PD of a print sheet 200 while discharging ink droplets of respective colors toward the paper face. Note that the number of colors of ink cartridges mounted on the print head unit 10 is not limited to four.

The head driving unit 20 includes a first pulley 21, a second pulley 22 and a head driving belt 23. The two pulleys 21 and 22 are provided across the paper transport unit 30, and the head driving belt 23 is looped around the two pulleys 21 and 22. The first pulley 21 is driven for rotation by a motor (not shown) that is controlled by the control unit 50. The second pulley 22 rotates following the first pulley through the head driving belt 23. The print head unit 10 is fixed to the head driving belt 23. This allows the print head unit 10 to reciprocally move over a print face of the print sheet 200 in accordance with rotation of the first pulley 21.

The paper transport unit 30 includes a first paper transport roller 31, a second paper transport roller 32 and a paper transport belt 33 that is looped around the two paper transport rollers 31 and 32. The first paper transport roller 31 is driven for rotation by a motor (not shown) that is controlled by the control unit 50. The second paper transport roller 32 rotates following the first paper transport roller 31 by the paper transport belt 33. By so doing, the print sheet 200 is transported on the paper transport belt 33 in the transport direction PD during printing.

The cap unit 40 is arranged in parallel with the paper transport unit 30 within a region in which the print head unit 10 is movable. The print head unit 10, when performing a maintenance process which will be described later, moves to a region, in which the cap unit 40 is located, so that nozzles 15 provided on the bottom face (face opposite the sheet 200) of the print head unit 10 can be sealed by the cap unit 40. The position of the print head unit 10 hereinafter referred to as “maintenance position MP”. Note that the details of the cap unit 40 will be described later.

The control unit 50 is formed of a logical circuit that mainly includes a microcomputer, and is provided with a central processing unit (not shown), a storage device (not shown). The control unit 50 is connected to the above described print head unit 10 through signal lines and controls the operation of the ink jet printer 100.

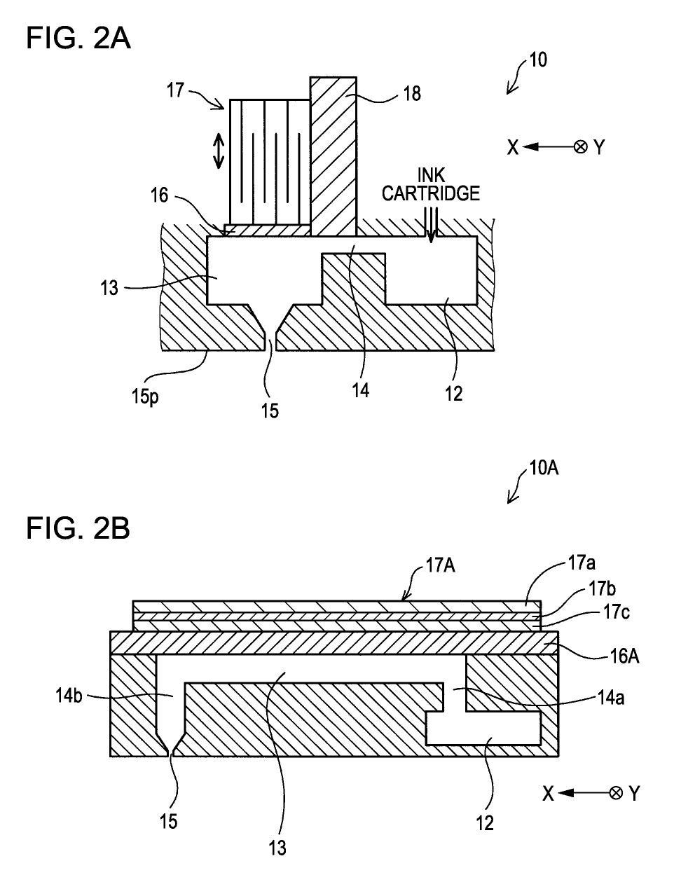

FIG. 2A is a schematic cross-sectional view that shows an internal structure of a discharge mechanism of the print head unit 10 for discharging ink droplets. FIG. 2A shows a vicinity of a nozzle 15 of the print head unit 10 as viewed in the direction of Y shown in FIG. 1. The print head unit 10 includes a common ink chamber 12 and pressure chambers 13, which are internal spaces that are filled with ink for each ink color.

Any one of the ink cartridges 11C, 11M, 11Y and 11K is mounted above the common ink chamber 12, and ink flows from the ink cartridge into the common ink chamber 12. The common ink chamber 12 is in fluid communication with the pressure chambers 13 through respective ink flow passages 14. Ink filled in the common ink chamber 12 flows into and out of the pressure chambers 13 through the ink flow passages 14. That is, the common ink chamber 12 serves as an ink buffer region for the pressure chambers 13.

A plurality of the nozzles 15 for discharging ink are provided at the bottom faces of the pressure chambers 13 so as to be arranged in parallel with one another in the (direction of Y). Hereinafter, the bottom face of the print head unit 10 is referred to as “nozzle face 15p”. Each nozzle 15 is formed to be a micro-through-hole that gradually tapers from the pressure chamber 13 toward the nozzle face 15p.

A diaphragm 16 and a piezoelectric element 17 are provided opposite each nozzle 15 in the pressure chamber 13. The diaphragm 16 is a plate-like member that has a thick portion that is in contact with the piezoelectric element 17 and an elastic thin portion provided around the thick portion. The thick portion vibrates in accordance with expansion and contraction of the piezoelectric element 17. Note that the thick portion and thin portion of the diaphragm 16 are not partitioned in the drawing.

The piezoelectric element 17 is a laminated piezoelectric vibrator that is formed by alternately laminating a piezoelectric body and an internal electrode, and is a longitudinal vibration mode piezoelectric vibrator that is able to expand and contract in a longitudinal direction (indicated by arrow) perpendicular to a laminated direction in accordance with a voltage applied. Each piezoelectric element 17 is fixed to a fixed base 18. The fixed base 18 is formed of a sufficiently rigid member that is able to efficiently transmit vibration of the piezoelectric element 17 to the diaphragm 16. With the above configuration, each piezoelectric element 17 applies a pressure, corresponding to an applied voltage, to pressure chamber 13 that is filled with ink, through the diaphragm 16. As a result, ink is discharged from the nozzle 15.

FIG. 2B is a schematic cross-sectional view that shows the internal structure of a print head unit 10A of a type different from the print head unit 10 described with reference to FIG. 2A. The print head unit 10A shown in FIG. 2B is formed so that the common ink chamber 12 is provided at a lower side (in a gravitational direction) with respect to the pressure chamber 13 when facing toward the sheet, and is in fluid communication with the pressure chamber 13 via an ink chamber side ink flow passage 14a. The pressure chamber 13 has a space that is wider in an x-axis direction and a y-axis direction and lower in height than the pressure chamber 13 of the print head unit 10 shown in FIG. 2A. The pressure chamber 13 of the print head unit 10A is in fluid communication with a nozzle 15 provided at a lower side in the gravitational direction via a nozzle side ink flow passage 14b.

An upper surface (top surface) in the gravitational direction of the pressure chamber 13 of the print head unit 10A is defined by a diaphragm 16A. A piezoelectric element 17A formed of laminated common upper electrode 17a, driving electrode 17b and common lower electrode 17c is fixedly arranged on the upper surface of the diaphragm 16A. The common upper electrode 17a and common lower electrode 17c of the piezoelectric element 17A are adjusted to a constant electric potential irrespective of a supplied drive signal, and the driving electrode 17b changes an electric potential in accordance with a supplied drive signal. As an electric potential difference is generated by a drive signal between these electrodes, the piezoelectric element 17A deforms as a whole because of a difference in degree of expansion and contraction in the lateral direction among the electrodes in order to make it possible to bend the diaphragm 16a in a direction to generate a negative pressure in the pressure chamber 13.

The aspect of the invention is not limited to the print head unit 10 of a type provided with the longitudinal vibration mode piezoelectric element 17 shown in FIG. 2A. The aspect of the invention may be, for example, applied to the print head unit 10A, or the like, of a type provided with the lateral vibration mode piezoelectric element 17A shown in FIG. 2B. Note that in the present exemplary embodiment, the ink jet printer 100 provided with the print head unit 10 shown in FIG. 2A will be described.

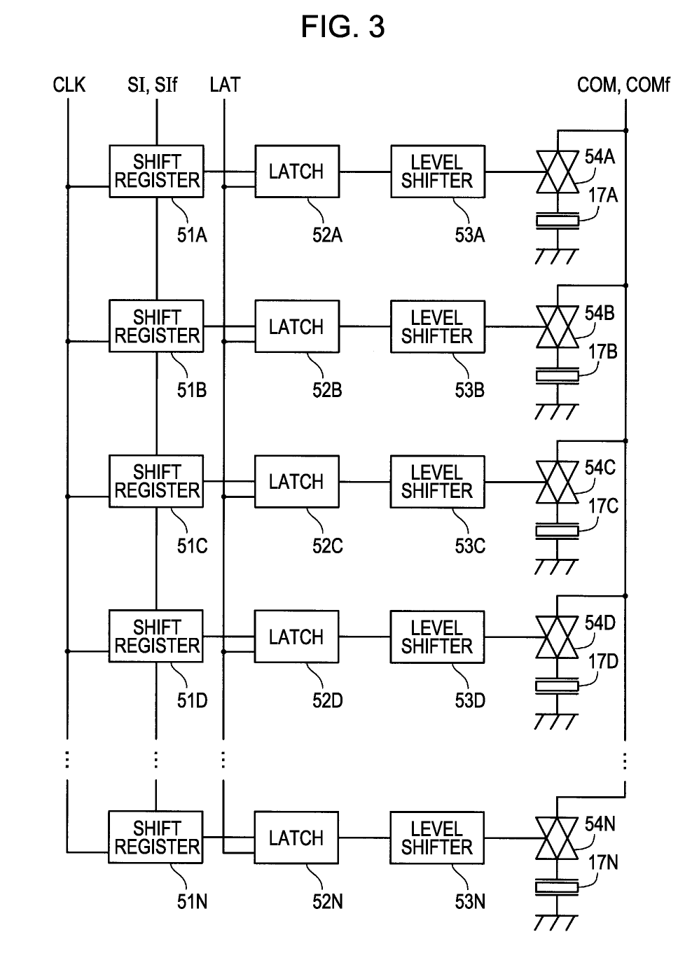

FIG. 3 is a block diagram that shows the electrical configuration of the print head unit 10. The print head unit 10 includes a plurality of shift registers 51A to 51N, a plurality of latch circuits 52A to 52N, a plurality of level shifters 53A to 53N and a plurality of switch circuits 54A to 54N in correspondence with the number of nozzles 15.

A print signal SI generated by the control unit 50 (FIG. 1) in accordance with print data is input from an oscillator circuit (not shown) to the shift registers 51A to 51N in synchronization with a clock signal CLK. Here, the print signal SI is a signal that represents whether to discharge an ink droplet for each of the nozzles 15. The print signal SI is latched by the latch circuits 52A to 52N in synchronization with a latch signal LAT. The latched print signals SI are respectively amplified by the level shifters 53A to 53N to voltages by which the switch circuits 54A to 54N may be driven, and are respectively supplied to the switch circuits 54A to 54N.

A drive signal COM is supplied from the control unit 50 to input sides of the switch circuits 54A to 54N, and piezoelectric elements 17A to 17N are connected to output side of the switch circuits 54A to 54N. Here, the drive signal COM is a signal that represents a voltage applied to each of the piezoelectric elements 17A to 17N. Note that the piezoelectric elements 17A to 17N are similar to the piezoelectric element 17 provided for each nozzle 15 as described with reference to FIG. 2A, and the reference numerals thereof are suffixed with A to N for representing correspondence with the circuit elements.

Each of the switch circuits 54A to 54N switch the supply of the drive signal COM to a corresponding one of the piezoelectric elements 17A to 17N in accordance with the print signal SI. For example, when the ink jet printer 100 performs printing, the switch circuits 54A to 54N supply the drive signal COM when the print signal SI is “1”, and interrupt the drive signal COM when the print signal SI is “0”. By so doing, the appropriate number of piezoelectric elements (17A to 17N) supplied with the drive signal COM, are driven to discharge ink droplets from the corresponding nozzles 15.

In some cases, bubbles may be trapped in ink inside the pressure chamber 13, when ink is initially filled from an ink cartridge or when printing process is continued. The bubbles absorb a pressure change in the pressure chamber 13 applied by the piezoelectric element 17. This may produce so-called dot omission, that is, ink droplets are not appropriately discharged from a portion of nozzles. In addition, ink may clog in a nozzle 15 because of thickened ink adhered to the nozzle 15 due to natural evaporation and cause nozzle clogging. For the above reasons, the ink jet printer 100 performs, other than when printing process is performed, various maintenance processes and procedures in order to appropriately discharge ink droplets from the nozzles.

The maintenance processes, for example, include so-called flushing in which ink is idly discharged from the nozzles 15 to eject bubbles or thickened ink from the nozzles 15 together with ink droplets. Here, the “idle discharge” means discharging of ink droplets, which is performed for the purpose other than the intended purpose (for example, printing). When this flushing is executed, the control unit 50 moves the print head unit 10 to the maintenance position MP (FIG. 1).

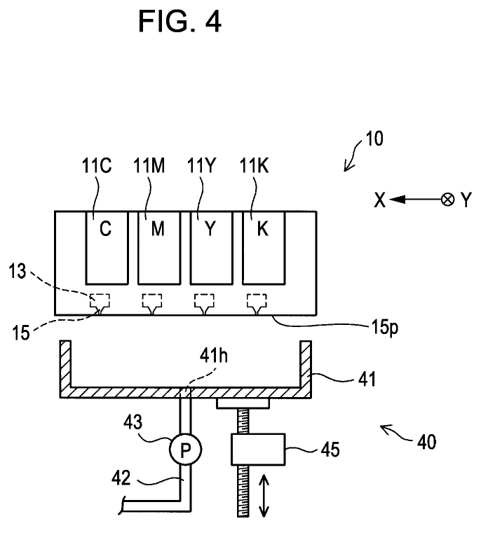

FIG. 4 is a view of the ink jet printer 100 when the print head unit 10 is moved to the maintenance position MP for maintenance process as viewed in the direction of arrow Y in FIG. 1. Note that FIG. 4 does not show the components of the ink jet printer 100 other than those of the print head unit 10 and cap unit 40 for the sake of convenience.

The cap unit 40 includes a cap body 41, an ink drain line 42, a pump 43 and a driving mechanism 45. The cap body 41 is a pan-shaped member that is arranged so as to be able to cover the nozzle face 15p. The cap body 41 is able to receive waste ink discharged from the nozzles 15 at the time of flushing.

A through-hole 41h is provided at the bottom center of the cap body 41. The ink drain line 42 is connected to the through-hole 41h. The pump 43 is provided in the ink drain line 42. The pump 43 is able to vacuum the waste ink accumulated in the cap body 41. The waste ink is guided through the ink drain line 42 to a waste ink treatment portion (not shown) for treating waste ink. The driving mechanism 45 raises the cap body 41 into close contact with the nozzle face 15p when ink is vacuumed by the pump 43. Note that at the time of flushing, the cap body 41 is maintained in a position away from the nozzle face 15p.

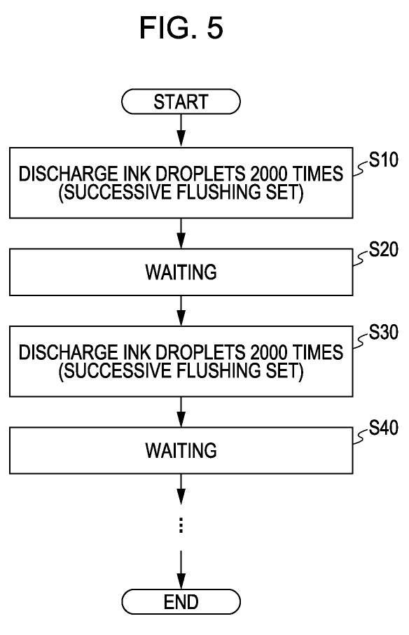

FIG. 5 is a flowchart that shows the steps of bubble removal flushing according to one exemplary embodiment of the invention. Here, the “bubble removal flushing” means a flushing operation that is intended to remove bubbles among flushing operations.

In step S10, the control unit 50 causes each of the nozzles 15 to idly discharge ink droplets 2000 successive times. Hereinafter, the process of successively idly discharging ink droplets is referred to as “successive flushing set”. In step S20, the control unit 50 waits for a predetermined interval (for example, about one second) and then performs the successive flushing set again in the following step S30. Here, the waiting interval is provided in step S20 in order to converge the vibration of ink and the vibration of the pressure chambers 13 due to the successive flushing set in the preceding process. Note that the ink jet printer 100 minutely vibrates the piezoelectric elements 17, at the waiting interval, to a degree such that ink droplets are not discharged in order to converge vibration of ink and vibration of the pressure chambers 13. By so doing, it is possible to effectively perform the following successive flushing set. In the bubble removal flushing, a series of successive flushing sets and the waiting intervals are repeated for a predetermined number of times.

During the execution of the above steps, control unit 50 outputs signals, different from those when printing is performed, to the print head unit 10 to cause ink droplets to be idly discharged from the nozzles 15.

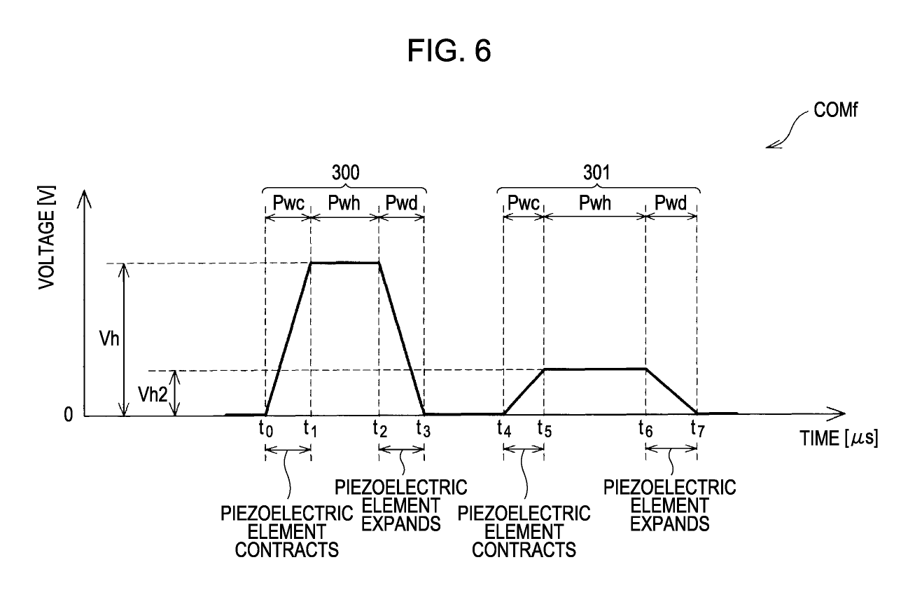

Now, signals that the control unit 50 outputs when bubble removal flushing is performed will be described. FIG. 6 is a graph that shows a drive signal that the control unit 50 outputs when bubble removal flushing is performed. The Y-axis represents a voltage and the X-axis represents time. The drive signal COMf for bubble removal flushing includes two drive pulses 300 and 301, which are substantially trapezoidal pulse signals.

The first drive pulse 300 is a drive signal for causing the nozzles 15 to idly discharge ink droplets in a successive flushing set in bubble removal flushing (steps S10 and S30 in FIG. 5). Hereinafter, the first drive pulse 300 is referred to as “bubble removal drive pulse 300”. On the other hand, the second drive pulse 301 is a drive signal for minutely vibrating the piezoelectric elements 17 in interval step (steps S20 and S40). Hereinafter, the second drive pulse 301 is referred to as “vibrating drive pulse 301”. It should be realized that drive pulses 300 and 301, shown in FIG. 6, are not sequential in time, but occur as explained above.

The bubble removal drive pulse 300 includes a first pulse portion Pwc, a second pulse portion Pwd and an intermediate pulse portion Pwh located between the first and second pulse portions Pwc and Pwd. In the first pulse portion Pwc, between time t₀ and time t₁, a voltage value of the piezoelectric element 17 increases from a ground state (voltage value 0) to Vh at a constant rate to cause the piezoelectric element 17 to contract. In the intermediate pulse portion Pwh, between time t₁ to time t₂, a voltage value of the piezoelectric element 17 is held constantly at Vh. In the second pulse portion Pwd, between time t₂ and time t₃, a voltage value of the piezoelectric element 17 returns from Vh to the ground state at a constant rate to cause the piezoelectric element 17 to expand. The width of each of the pulse portions Pwc, Pwh and Pwd will be described later.

The vibrating drive pulse 301, as well as the bubble removal drive pulse 300, include three pulse portions Pwc, Pwh and Pwd. Specifically, in the vibrating drive pulse 301, a portion from time t₄ to time t₅ is a first pulse portion Pwc, a portion from time t₅ to time t₆ is an intermediate pulse portion Pwh, and a portion from time t₆ to time t₇ is a second pulse portion Pwd. In the vibrating drive pulse 301, a voltage value of the piezoelectric element 17 increases to Vh2 at a constant rate in the first pulse portion Pwc. The voltage value Vh2 is lower than the voltage value Vh of the bubble removal drive pulse 300. Voltage level of Vh2 is such that ink is not discharged from the nozzle 15. Note that the widths of the pulse portions Pwc, Pwh and Pwd of the vibrating drive pulse 301 may be respectively different from the widths of the pulse portions Pwc, Pwh and Pwd of the bubble removal drive pulse 300.

When bubble removal flushing is performed, the control unit 50 outputs the drive signal COMF, in which these two drive pulses 300 and 301 are repeated alternately and successively at constant intervals are supplied to the switch circuits 54A to 54N of the print head unit 10 instead of the drive signal COM (FIG. 3). In addition, the control unit 50, instead of the print signal SI output when printing is performed, supplies a signal for bubble removal flushing (“flushing signal SIf”) to the switch circuits 54A to 54N via the shift registers 51A to 51N, the latch circuits 52A to 52N and the level shifters 53A to 53N.

In accordance with the flushing signal SIf, the switch circuits 54A to 54N switch supply of the drive signal COM to the piezoelectric elements 17A to 17N. As a result of this switching operation, half of the piezoelectric elements 17 (referred to as “first piezoelectric element group”) are supplied with only the bubble removal drive pulse 300 at constant intervals, and the remaining half of the piezoelectric elements 17 (referred to as “second piezoelectric element group”) are supplied with only the vibrating drive pulse 301 at predetermined intervals. In addition, the types of the drive pulses supplied respectively to the first and second piezoelectric element groups are switched every 2000 times idle discharge is performed in the successive flushing set. That is, the first and second piezoelectric element groups each alternately perform a successive flushing set and an interval step. In one embodiment, the successive flushing set, the frequency at which the bubble removal drive pulse 300 is supplied is desirably 1 kHz to 5 kHz.

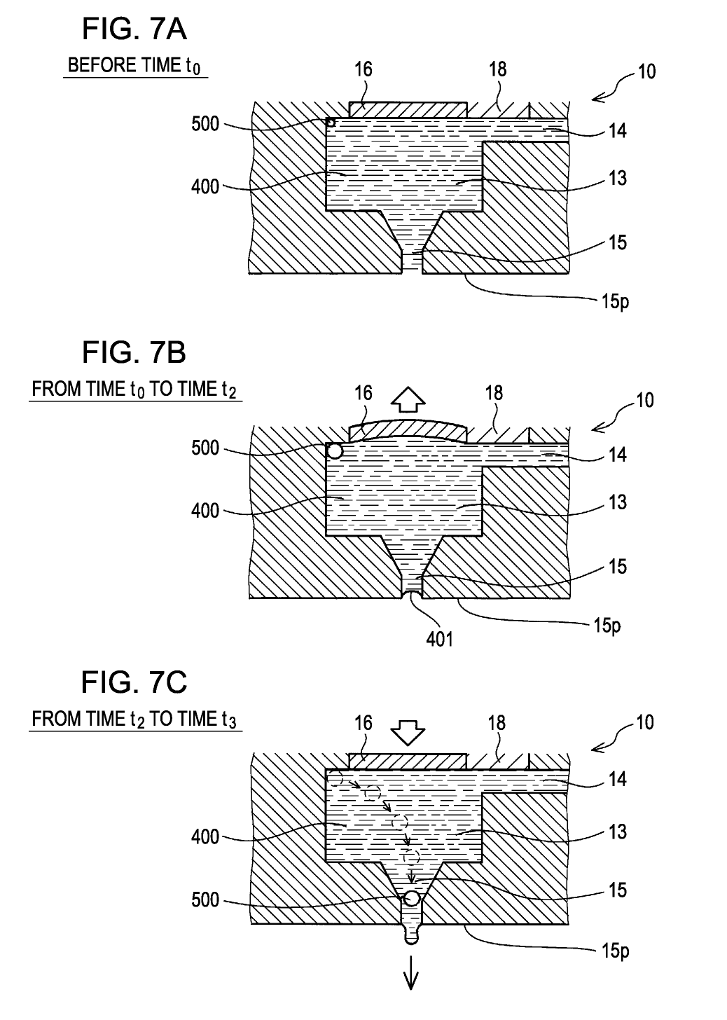

FIG. 7A to FIG. 7C are schematic views that schematically show operation of the print head unit 10 in response to the drive pulse 300. FIG. 7A to FIG. 7C are enlarged views of the pressure chamber 13 of the print head unit 10 shown in FIG. 2A, and the piezoelectric element 17 and the common ink chamber 12 are not shown in the drawings.

FIG. 7A shows a state of the pressure chamber 13 before receiving the bubble removal drive pulse 300 (before time to). The pressure chamber 13 is filled with ink 400, and a bubble 500 is trapped in the ink 400. Note that the bubble 500 tends to be accumulated in a region located on the upper side of the pressure chamber 13 and opposite the ink flow passage 14.

FIG. 7B shows a state of the pressure chamber 13 from time to time t₂ shown in FIG. 6. The piezoelectric element 17 (FIG. 2A), when receiving the first pulse portion Pwc between time t₀ and time t₁, contracts in accordance with an increase in applied voltage. Then, as shown in FIG. 7B, the diaphragm 16 bends outward of the pressure chamber 13 (direction of arrow), and a negative pressure is applied to the ink 400 in the pressure chamber 13. Note that a meniscus 401 formed at the nozzle 15 at this time increases the degree of bending in the same direction as that of the diaphragm 16. Then, the diaphragm 16 is kept bent from time t₁ to time t₂. Between time t₀ and time t₂, the diameter of the bubble 500 increases with a decrease in pressure in the pressure chamber 13.

FIG. 7C shows a state of the pressure chamber 13 from time t₂ to time t₃. As a result of the second pulse portion Pwd of the bubble removal drive pulse 300, a voltage value applied to the piezoelectric element 17 returns to a ground value (FIG. 6), and the piezoelectric element 17 also returns to a normal state. That is, the diaphragm 16 returns from the bent state to a flat state. As a result, pressure is exerted by the diaphragm 16 on the ink 400 causing the ink 400 to discharge from the nozzle 15. At this time, the bubble 500 also gradually approaches the nozzle 15 when ink is discharged, and is finally ejected outward from the nozzle 15. FIG. 7C shows locus of the bubble 500 moving toward the nozzle 15 when a number of the bubble removal drive pulses 300 are generated.

Here, as described with reference to FIG. 7B, the diameter of the bubble may increase between time t0 and t1. Therefore, a bubble having a micro-diameter may also be discharged.

As can be understood from the above description, by decreasing the pressure in the pressure chamber 13 to increase the diameter of the bubble 500 as much as possible, it is possible to further reliably discharge and remove the bubble 500. Thus, the width of the first pulse portion Pwc (FIG. 6) of the bubble removal drive pulse 300 is desirably set to be equal to or smaller than half the Helmholtz resonance period Tc of the ink 400 in the pressure chamber 13. Here, the “Helmholtz resonance period Tc” is a natural vibration period when a vibrational wave generated through increase and decrease in volume of the pressure chamber 13 propagates through the ink 400 in the pressure chamber 13, and is determined on the basis of the shapes of the pressure chamber 13, ink flow passage 14 and nozzle 15.

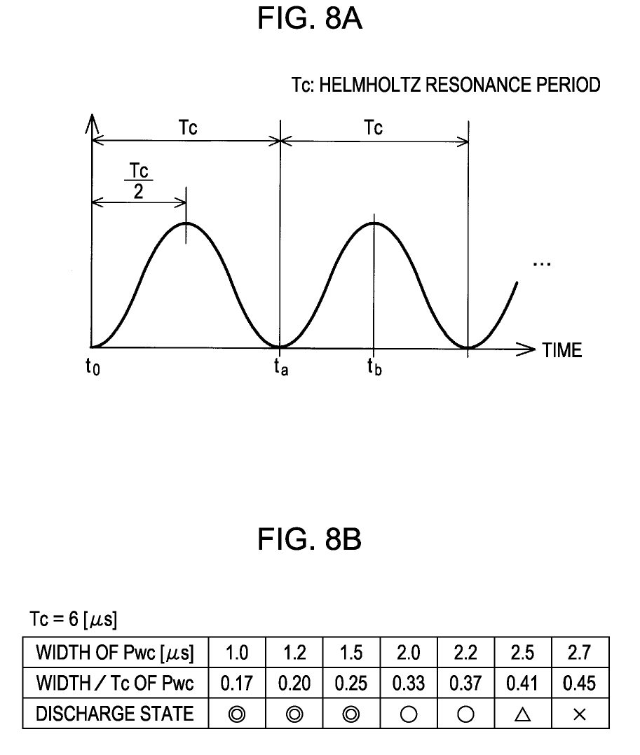

FIG. 8A is a graph that shows a state of ink vibration in conformity with the Helmholtz resonance period Tc. Theoretically, it may be understood that as the pressure in the pressure chamber 13 is decreased from time t₀ over a period of about half the Helmholtz resonance period Tc, vibration of ink 400 is maximal. Then, by setting the width of the first pulse portion Pwc to be equal to or smaller than half the Helmholtz resonance period Tc, a further large negative pressure may be generated in the pressure chamber 13, and the diameter of the bubble 500 may be increased.

FIG. 8B is a table that shows the experimental results for which a discharge state is checked when bubble removal flushing is performed with different widths of the first pulse portion Pwc in the print head unit having a Helmholtz resonance period Tc of 6 μs. Note that the double circle in the table represents that, after bubble removal flushing, bubbles have been removed from almost all the nozzles and no dot omission is detected. The single circle in the table represents that, after bubble removal flushing, a bubble remains and dot omission occurs in at least one and no more than 30 percent of nozzles. In addition, the triangle represents that dot omission occurs in no more than 50 percent of nozzles, and the cross-out represents that dot omission occurs in more than 50 percent of nozzles.

As shown in the table, the width of the first pulse portion Pwc is desirably 0.4 times or less of the Helmholtz resonance period Tc, and, particularly, is desirably one-third or less of the Helmholtz resonance period Tc or 0.3 times or less of the Helmholtz resonance period Tc. However, it is described with reference to FIG. 8A that the pulse width is set to be equal to or smaller than half the Helmholtz resonance period Tc. This difference may be regarded that the timing at which the diameter of a bubble varies by resonating with the piezoelectric element 17 because of the natural frequency (which will be described later) of the bubble. Note that the width of the first pulse portion Pwc is desirably shorter the better; actually, the width is more desirably set to about 1.5 μs in consideration of the response of the piezoelectric element 17 to the drive pulse.

The width of the second pulse portion Pwd of the bubble removal drive pulse 300 (time t₂ to time t₃ in FIG. 6), as well as the first pulse portion Pwc, is desirably set to be equal to or smaller than half the Helmholtz resonance period Tc. The reason will be described below. Generally, a speed at which a bubble in fluid disappears is known to be expressed as the following mathematical expression (1).

Speed at which bubble disappears Vm=k×S×(∂P/∂t) (1)

Here, P is a pressure in the pressure chamber, S is a surface area of the bubble, and k is a constant.

The mathematical expression (1) indicates that, when a bubble has the same surface area, a speed at which the bubble disappears is maximal when a pressure variation in fluid is maximal. That is, by maximizing a pressure variation in the ink 400 at the second pulse portion Pwd, it is possible to maximize the speed at which the bubble 500 disappears, and it is possible to further effectively remove the bubble 500. Therefore, in the present embodiment, a pressure is applied to the ink 400 in time width that is equal to or smaller than half the Helmholtz resonance period Tc in which vibration of the ink 400 is maximal and will maximize the pressure variation in the ink 400.

In addition, the width of the second pulse portion Pwd is desirably equal to or larger than half the natural vibration period Ta of the piezoelectric element 17. With the above width, it is possible to start applying pressure to the ink 400 at a timing to resonate with the natural vibration of the piezoelectric element 17. Thus, it is possible to generate a further large pressure in the ink 400. It may be beneficial to keep Pwd and Pwc short, for example 1.5 μs in consideration of the response of the piezoelectric element 17.

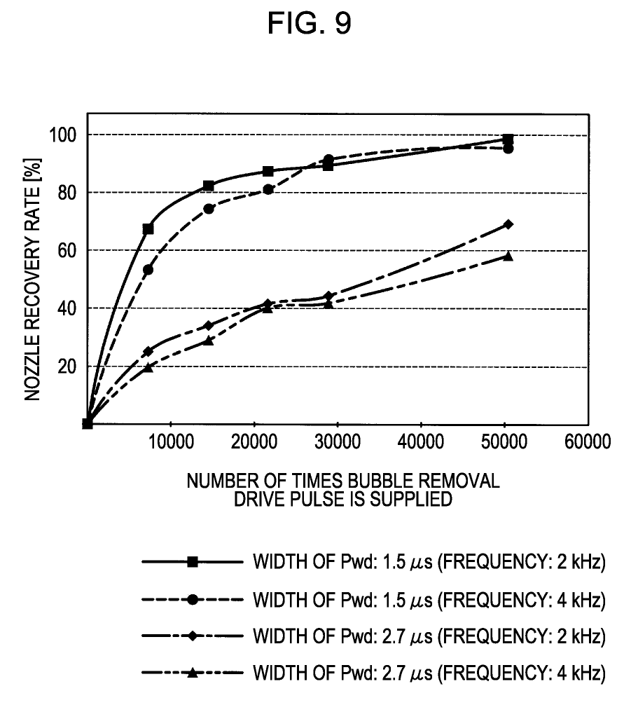

FIG. 9 is a graph that illustrates an experimental result illustrating a difference in nozzle recovery rate against a width of the second pulse portion Pwd. Here, the “nozzle recovery rate” is a ratio of the number of nozzles recovered after maintenance process is performed to the number of nozzles in which trouble such as ink clogging has been occurring. In the experiment, all the nozzles 15 of the print head unit 10 were equally clogged with ink, idle discharge was performed using the bubble removal drive pulse 300 in which the width of the second pulse portion Pwd is equal to or smaller than half the Helmholtz resonance period Tc, and then the nozzle recovery rate was measured. Specifically, two types of bubble removal drive pulses 300 having second pulse portions Pwd of 1.5 μs and 2.7 μs were supplied at a frequency of 2 kHz and at a frequency of 4 kHz, and then the nozzle recovery rate against the number of the drive pulses 300 supplied was measured. Note that the width of the first pulse portion Pwc was set to the same as that of the second pulse portion Pwd, and the intermediate pulse portion Pwh was set to 3.0 μs. From the graph, it appears that, the shorter the second pulse portion Pwd is, the smaller number of times idle discharge is performed to make it possible to recover the nozzles.

As described above, the ink 400 in the pressure chamber 13 generates Helmholtz resonance because of the first pulse portion Pwc. However, as a pressure is applied by the piezoelectric element 17 in synchronization with the vibration of the ink 400, it is possible to generate a further large pressure. Then, the width of the intermediate pulse portion Pwh is also desirably set in accordance with the Helmholtz resonance period Tc. Specifically, it is desirable to apply a pressure in a time period (from time tₐ to time t_{b}) in which vibration of the ink 400 tends to increase as shown in the graph of FIG. 8A, and it is more desirable to apply a pressure at time closer to time t_{b}. More specifically, in consideration of the width of the first pulse portion Pwc, the width of the intermediate pulse portion Pwh is desirably set to be at least larger than half the Helmholtz resonance period Tc, and more desirably set to be equal to or larger than 0.7 times the Helmholtz resonance period Tc.

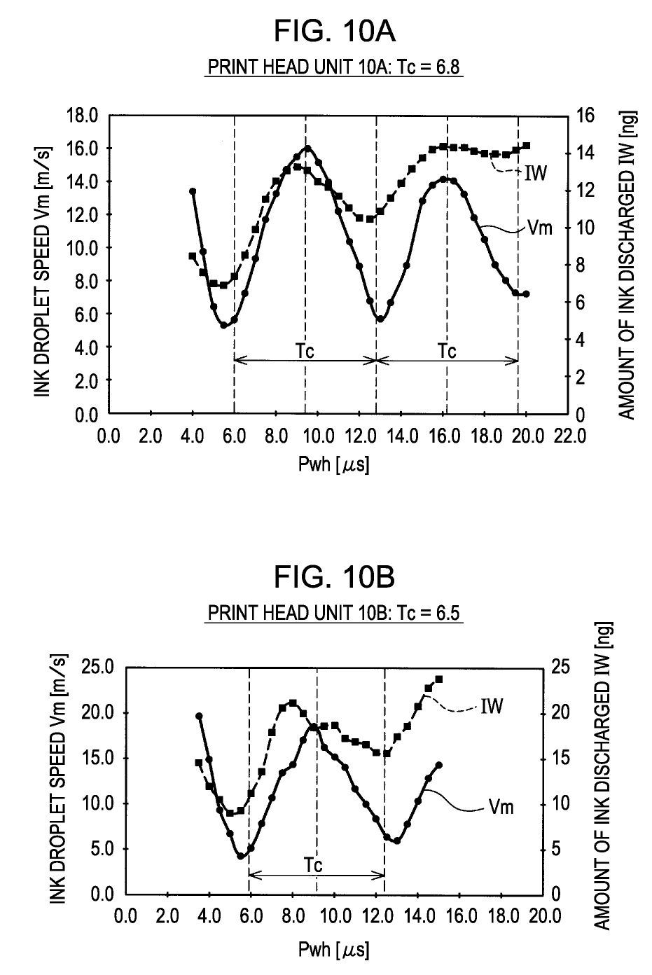

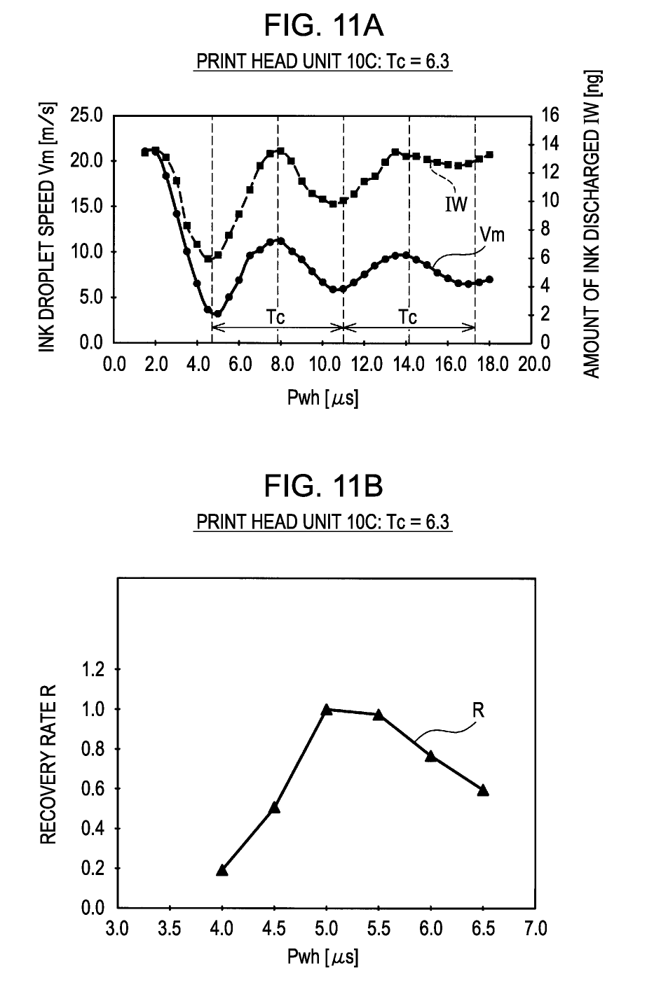

FIG. 10A, FIG. 10B and FIG. 11A respectively show experimental results of a discharged ink droplet speed Vm and an amount of ink discharged IW when ink droplets are idly discharged with different widths of the intermediate pulse portion Pwh respectively for three different types of print head units 10A, 10B and 11A. FIG. 10A shows the experimental result of the print head unit 10A when the Helmholtz resonance period Tc is 6.8. FIG. 10B shows the experimental result of the print head unit 10B when the Helmholtz resonance period Tc is 6.5. In addition, FIG. 11A shows the experimental result of the print head unit 10C when the Helmholtz resonance period Tc is 6.3. Note that the print head units 10A and 10B are of a type having the structure described with reference to FIG. 2A, and the print head unit 11A is of a type having the structure described with reference to FIG. 2B. In addition, the width of each of the first and second pulse portions Pwc and Pwd of the bubble removal drive pulse 300 supplied to each of the print head units 10A, 10B and 10C was set to 1.5 μs.

From these graphs, it appears that, with an increase in width of the intermediate pulse portion Pwh, a discharged ink droplet speed Vm and an amount of ink discharged IW both repeatedly increase and decrease at substantially constant period, and the width of the period substantially coincides with the width of the period of each Helmholtz resonance period Tc. Note that the timings of the first lower peaks of these graphs (about 5 μs) deviate from the Helmholtz resonance period Tc. However, this is because the width of the first pulse portion Pwc is smaller than half the Helmholtz resonance period Tc. As described above, these graphs indicate that, when application of a pressure to the pressure chamber 13 is started at a timing in synchronization with the Helmholtz resonance period Tc, a further large pressure is generated in the ink to make it possible to increase a discharged ink droplet speed Vm and an amount of ink discharged IW.

FIG. 11B is a graph that shows a relationship between a width of the intermediate pulse portion Pwh, obtained through experiment using the above described print head unit 11A, and a nozzle recovery rate R. As shown in these graphs, the graph of nozzle recovery rate R has a portion that increases with an ink droplet speed Vm within a range in which the width of the intermediate pulse portion Pwh is about 4.0 to 5.0 microseconds. However, the nozzle recovery rate R reaches a maximum value earlier than the ink droplet speed Vm and, after that, tends to decrease. Thus, the width of the intermediate pulse portion Pwh is desirably smaller than the width in which the ink droplet speed Vm is maximum, and is desirably at least smaller than the Helmholtz resonance period Tc.

In addition, when focusing on the graphs of the amount of ink discharged IW shown in FIG. 10A, FIG. 10B and FIG. 11A, it appears that, with an increase in width of the intermediate pulse portion Pwh, the amount of ink discharged IW increases and decreases at constant periods but tends to increase as a whole. It is desirable that small amount of ink is consumed in the maintenance process the width of Therefore, the intermediate pulse portion Pwh is desirably a value at which the recoverability of the nozzles is maintained while an increase in the amount of ink consumed is suppressed. Thus, even when the amount of ink discharged IW is considered, the width of the intermediate pulse portion Pwh is desirably smaller than the Helmholtz resonance period Tc.

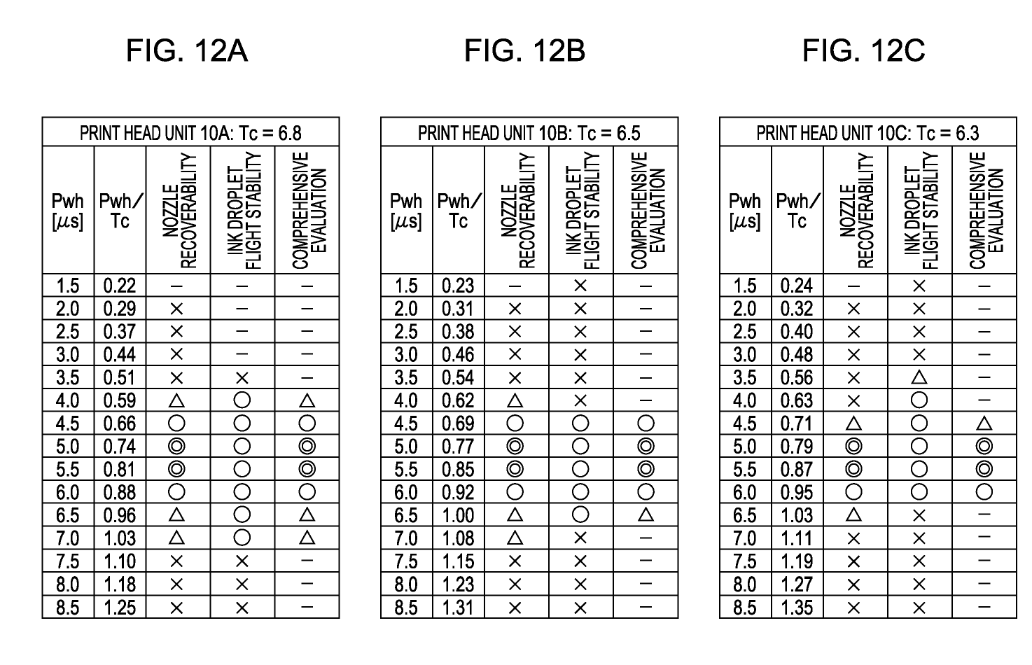

FIG. 12A to FIG. 12C are tables that show evaluation results of maintenance effect when the bubble removal drive pulses 300 having the intermediate pulse portions Pwh with different widths as shown in FIGS. 10A, 10B and 11A were supplied to the print head units. That is, the recoverability of the nozzles and flight stability of ink droplets were evaluated for each width of the intermediate pulse portion Pwh, and comprehensive evaluation was performed on the basis of the evaluation results.

Here, the “recoverability of the nozzles” means evaluation on nozzle recovery effect determined on the basis of the nozzle recovery rate. In the tables FIG. 12A to FIG. 12C, the “double circle” represents that the recovery rate ranges from 90% to 100%, the “single circle” represents that the recovery rate ranges from 70% to 90%, the “triangle” represents that the recovery rate ranges from 50% to 70%, and the “cross-out” represents that the recovery rate is lower than 50%. In the above evaluation, as in the case of the description with reference to FIG. 9, the nozzle recovery rate was measured in a state where all the nozzles were equally clogged with ink.

In addition, the “flight stability of ink droplets” means straightness of loci of discharged ink droplets or accuracy with which discharged ink droplets land at target landing positions. In idly discharging ink in maintenance process, the flight stability of ink droplets better to be higher. This is because soiling of the print head unit due to ink droplets landed out of predetermined points and occurrence of mist in accordance with idle discharge is suppressed.

The flight stability of ink droplets was evaluated in the following manner. That is, the bubble removal drive pulse 300 was supplied simultaneously to the plurality of nozzles 15 arranged in a line, and the nozzles 15 were caused to successively discharge ink droplets toward a print sheet being transported at a constant speed at constant time intervals. Then, the state of arrangement of ink droplets that landed on the print sheet was observed.

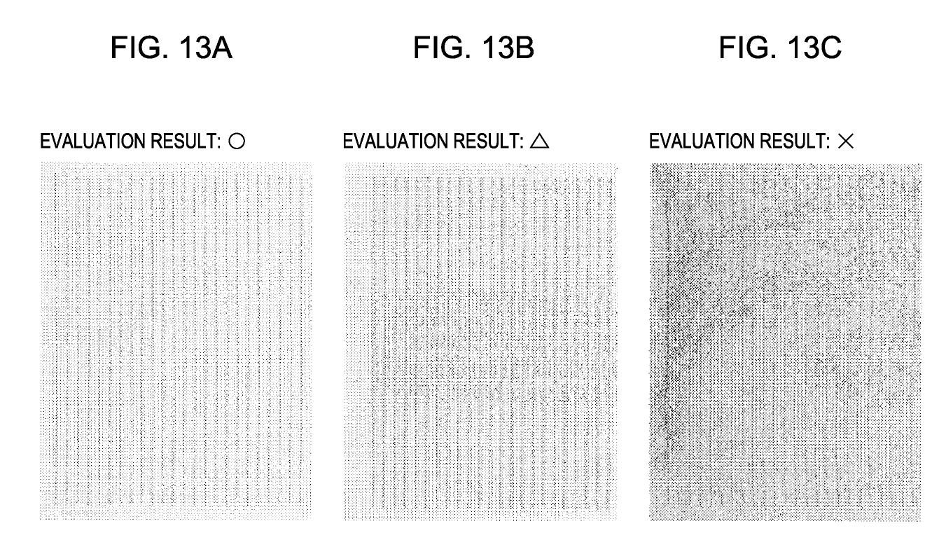

FIG. 13A to FIG. 13C are images that respectively show the print sheets on which the discharged ink droplets obtained through the above method landed. In the image shown in FIG. 13A, the marks of the ink droplets of each nozzle are arranged at equal intervals in substantially a straight line in the direction in which the print sheet was transported, no adhesion of redundant mist is observed on the print sheet. In the image shown in FIG. 13B, as compared with the image shown in FIG. 13A, a portion of the marks of the ink droplets are located outside the lines, and adhesion of mist is observed near the center of the print sheet. In the image shown in FIG. 13C, as compared with the image shown in FIG. 13B, the lines of the marks of the ink droplets are further distorted, and adhesion of mist is observed over the entire print sheet. In the tables of FIG. 12A to FIG. 12C, the results of landing of the ink droplets as substantially shown in the images of FIG. 13A to FIG. 13C are respectively indicated by “circle”, “triangle” and “cross-out”.

The results of comprehensive evaluation shown in the tables of FIG. 12A to FIG. 12C are “double circle” when the evaluation of the recoverability of the nozzles is “double circle” and the evaluation of the flight stability of ink droplets is “circle”. In addition, evaluation is “circle” when the evaluation of the recoverability of the nozzles and the evaluation of the flight stability of ink droplets both are “circle”. Evaluation is “triangle” when the evaluation of the recoverability of the nozzles is “triangle” and the evaluation of flight stability of ink droplets is “circle”. From the above comprehensive evaluation results, it may be desirable that the width of the intermediate pulse portion Pwh is set as follows. That is, the width of the intermediate pulse portion Pwh is desirably 0.65 times the value to the actual value of the Helmholtz resonance period Tc, and is more desirably 0.72 times to 0.95 times the Helmholtz resonance period Tc. Furthermore, the width of the intermediate pulse portion Pwh is most desirably 0.72 times to 0.90 times the Helmholtz resonance period Tc. Note that these real numbers shown to the second decimal place are rounded off to the second decimal place.

In this way, when the width of each of the pulse portions Pwc, Pwh and Pwd of the bubble removal drive pulse 300 is set in accordance with the Helmholtz resonance period, the recoverability of the nozzles is improved while the flight stability of ink droplets in idle discharge is improved in order to make it possible to suppress occurrence of soiling of the print head unit. In addition, it is possible to suppress an increase in the amount of ink consumed in maintenance process. As can be understood from the experimental results shown in FIG. 10A to FIG. 12C, the above described advantageous effects may also be similarly obtained from the print head units having different structures as shown in FIG. 2A and FIG. 2B or from a print head unit having another type of structure.

In one embodiment, the width of the intermediate pulse portion Pwh is set to a different value for each successive flushing set (step S10, S30 in FIG. 5). More specifically, the width of the intermediate pulse portion Pwh of the bubble removal drive pulse 300 generated in step S30 is set to be shorter than that generated in step S10, and subsequently, the width is set to be shorter for each successive flushing set. This means that every time the successive flushing set is repeated, a removal target diameter of a bubble is reduced. By so doing, the bubble removal flushing is able to further reliably perform removal of bubbles. Note that the width of the intermediate pulse portion Pwh is desirably varied within a range larger than or equal to half the Helmholtz resonance period Tc and smaller than the Helmholtz resonance period Tc.

In the ink jet printer 100 that performs bubble removal flushing using the bubble removal drive pulse 300, a micro-bubble that is present in the pressure chamber 13 may also be discharged from the nozzle 15 by increasing its diameter. In addition, because the bubble removal drive pulses 300 that are intended for bubbles having different diameters are sequentially generated, it is possible to further effectively perform removal of bubbles.

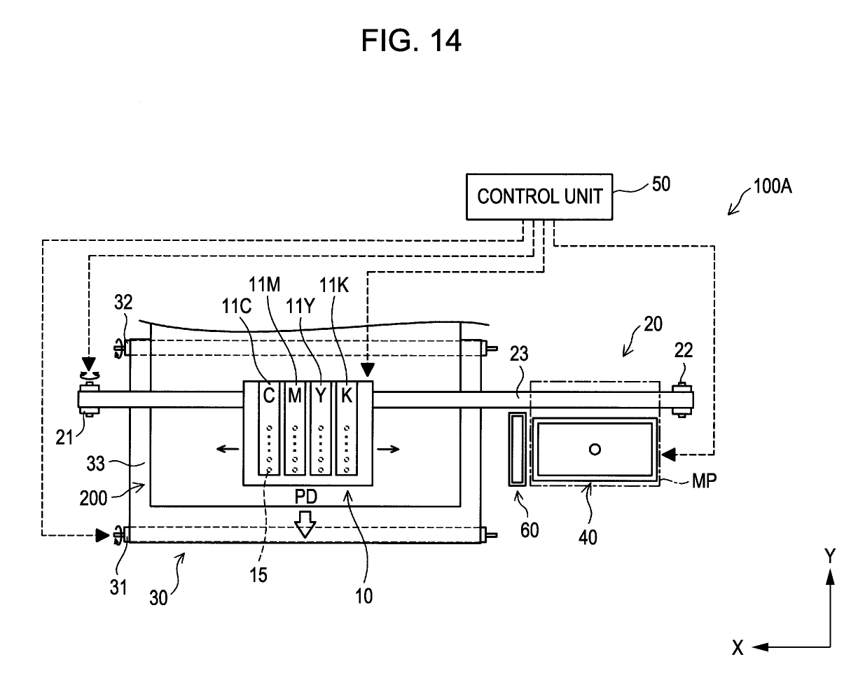

FIG. 14 is a schematic view that shows a configuration of an ink jet printer 100A according to another exemplary embodiment of the invention. FIG. 14 is substantially the same as that of FIG. 1 except that a wiper unit 60 is provided between the paper transport unit 30 and the cap unit 40.

FIG. 15 is a schematic view of the ink jet printer 100A when the print head unit 10 is moved to the maintenance position MP for maintenance process as viewed in the direction of arrow Y in FIG. 14. FIG. 15 is substantially the same as FIG. 2A except that the wiper unit 60 is added. The wiper unit 60 includes a wiper blade 61 that is formed of rubber or flexible resin. The wiper blade 61 is movable vertically by means of a driving mechanism 65.

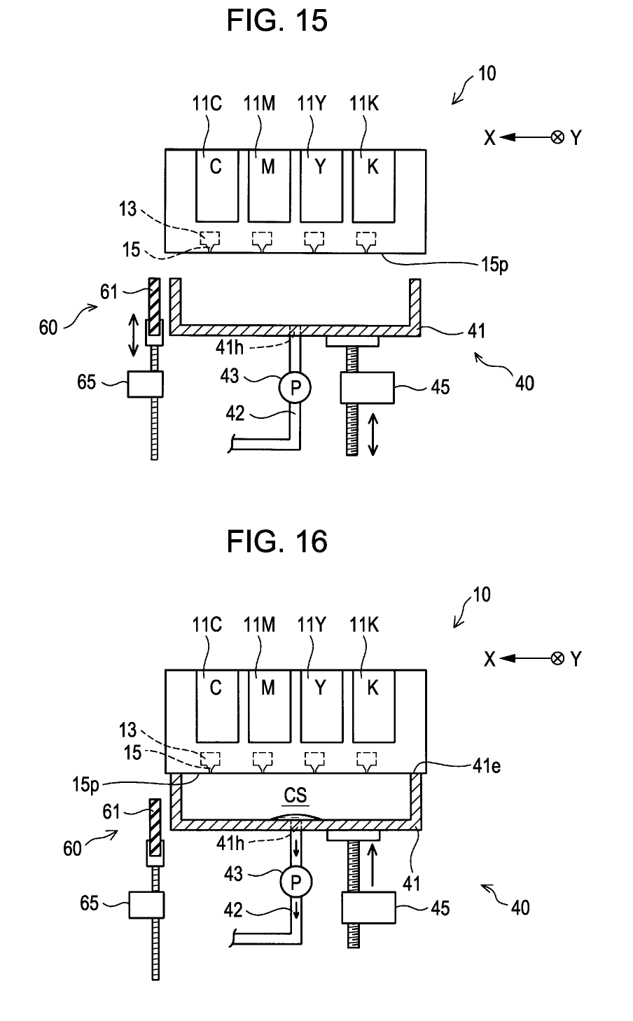

FIG. 16 shows a state in which the cap unit 40 hermetically seals the nozzles 15 in such a manner that the end face 41e of the cap body 41 of the cap unit 40 contacts the nozzle face 15p of the print head unit 10. The cap unit 40 vacuums ink from the nozzles 15 in such a manner that the pump 43 is operated in this state to apply a negative pressure in a space covered with the cap body 41 (ink vacuuming process). Hereinafter, the space closed by the cap body 41 is referred to as “cap closed space CS”.

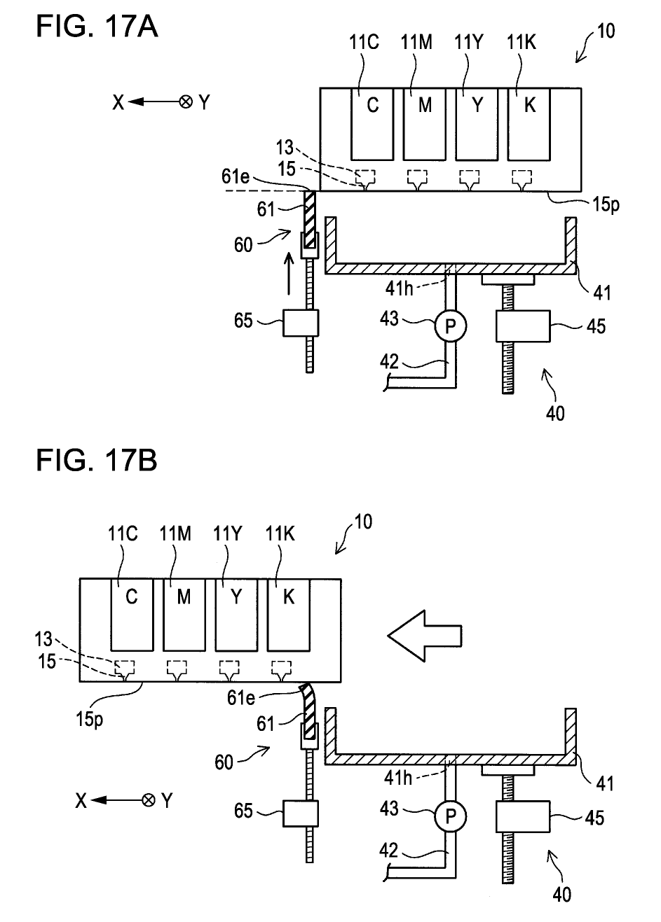

FIG. 17A and FIG. 17B are schematic views that illustrate the process of wiping the nozzle face 15p by the wiper unit 60 (wiping process). The nozzle face 15p can be smeared with thickened ink adhered to nozzle openings. In addition, at the time of the above ink vacuuming process, an ink smear may be adhered to the nozzle face 15p due to contact of the nozzle face 15p with the end face 41e of the cap body 41. An accumulated smear on the nozzle face 15p causes poor performance of the print head unit 10. For this reason, the nozzle face 15p is cleaned through wiping process using the wiper unit 60.

FIG. 17A shows a state in which the distal end portion 61e of the wiper blade 61 is moved upward (indicated by arrow) to substantially the same level as that of the nozzle face 15p. Note that at this time, the cap body 41 of the cap unit 40 is not in contact with the nozzle face 15p. FIG. 17B shows a state in which the print head unit 10 is moved in the direction of arrow X while the wiper blade 61 is in contact with the nozzle face 15p. In this way, by moving the distal end portion 61e of the wiper blade 61 on the nozzle face 15p, it is possible to wipe off a smear on the nozzle face 15p.

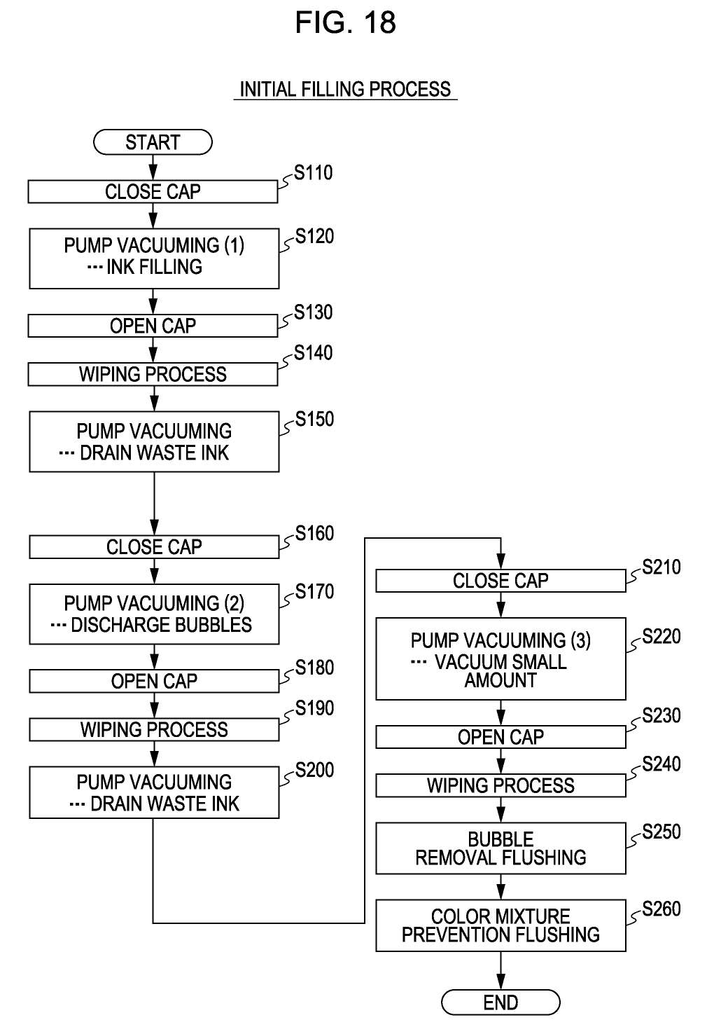

FIG. 18 is a flowchart that shows the steps of initial filling process. Here, the “initial filling process” means a process in which, when at least one of the ink cartridges 11C, 11M, 11Y, and 11K mounted on the print head unit 10 is replaced, the common ink chamber 12 and the pressure chambers 13 connected to the ink cartridge are filled with ink. Note that replacement of an ink cartridge and initial filling process are performed in a state where the print head unit 10 is placed at the maintenance position MP.

In step S110 to step S120, the ink vacuuming process described with reference to FIG. 16 is performed. Through the above process, the pressure chambers 13 are filled with ink. At this time, the cap unit 40 has adhered ink that has been vacuumed from the nozzles 15.

After that, a negative pressure applied to the cap closed space CS (FIG. 16) is released, and in step S130, the cap unit 40 is moved to an initial position to have the nozzles 15 uncovered. In step S140, the wiping process of wiping the nozzle face using the wiper unit 60 is performed and in step S150, the pump 43 is operated to drain waste ink, adhered to the cap unit 40, through the ink drain line 42. Hereinafter, the process that is performed through a series of processes from step S110 to step S150 is referred to as “first filling process”.

In step S160 to step S200, the same processes as those of the first filling process are repeated (second filling process). Furthermore, in the following step S210 to step S240 as well, the same processes as those of the first and second filling processes are performed. However, the amount of vacuuming by the pump 43 at this time may be smaller than those of the previous processes. The filling process of step S210 to step S240 is particularly referred to as “small amount filling process”.

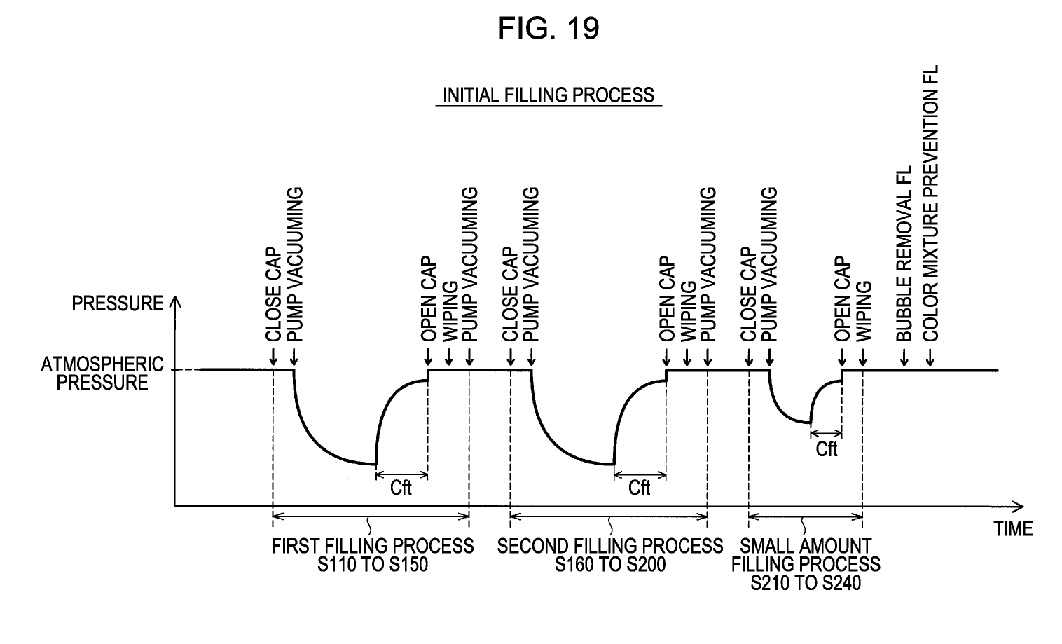

FIG. 19 is a graph that shows a change in pressure over time in the cap closed space CS (FIG. 16) in the initial filling process. The ink vacuuming process is performed multiple times in order to further reliably perform ink filling by reducing bubbles trapped in an ink filling region from the common ink chamber 12 to the pressure chambers 13. However, bubbles may still possibly be trapped in the pressure chambers 13.

For this reason, in step S250 (FIG. 18), bubble removal flushing (FIG. 3) that uses the drive pulse 300 (FIG. 6) is performed. By so doing, bubbles in the pressure chambers 13 are further reliably removed to suppress the occurrence of dot omission in the nozzles 15.

In step S260, color mixture prevention flushing, which is different from the bubble removal flushing in step S250, is further performed. Here, the “color mixture prevention flushing” will be described. At the time of the above described ink vacuuming process, in some time frames Cft (FIG. 19), the pressure in the cap closed space CS increases from a negative pressure to about atmospheric pressure. At this time, within the cap closed space CS (FIG. 16), misty ink may return back toward the nozzle face 15p. This may cause ink, which is different in color from discharged ink, to be mixed into the nozzles 15. In addition, in the wiping process, when the nozzle face 15p is wiped off by the wiper blade 61, different color ink may be mixed into the nozzles 15. The color mixture prevention flushing is a flushing operation that prevents discharging different color ink that is mixed into the nozzles 15.

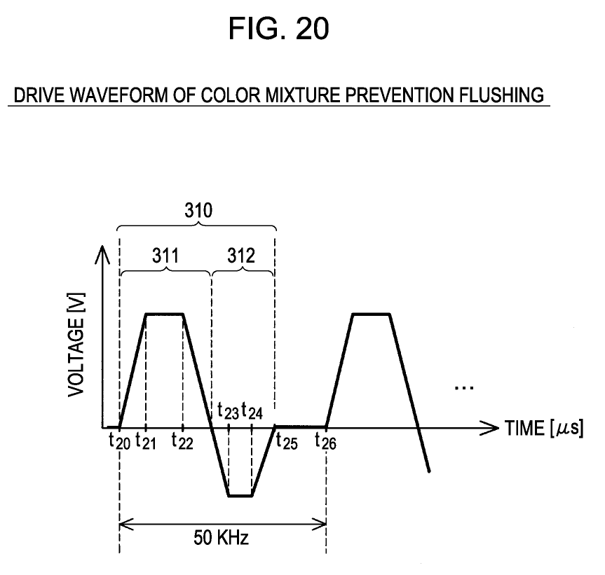

FIG. 20 is a graph that shows a drive pulse that the control unit 50 generates for the piezoelectric elements 17 in color mixture prevention flushing. The drive pulse 310, which is different from the drive pulse 300 (FIG. 6) in the bubble removal flushing, is to discharge a large amount of ink at a time.

The drive pulse 310 includes a first pulse portion (from time t₂₀ to time t₂₁) that increases a voltage at substantially a constant rate from a ground voltage and a second pulse portion (from time t₂₁ to time t₂₂) that maintains a constant voltage for a predetermined period of time. In addition, the drive pulse 310 further includes a third pulse portion (from time t₂₂ to time t₂₃) that decreases a voltage at substantially a constant rate to a negative voltage, a fourth pulse portion (from time t₂₃ to time t₂₄) that maintains a constant negative voltage for a predetermined period of time, and a fifth pulse portion (from time t₂₄ to time t₂₅) that increases a voltage at substantially a constant rate to the ground voltage. That is, the drive pulse 310 includes a first substantially trapezoidal pulse 311 that generates a positive voltage and a second substantially trapezoidal pulse 312 that generates a negative voltage.

The drive pulse 310 includes the second substantially trapezoidal pulse 312 in order to make it possible to suppress occurrence of excessive vibration in an ink surface in the nozzle 15 and perform successive ink discharges for a short period of time. For example, in the color mixture prevention flushing, the control unit 50 is able to generate the drive pulse 310 multiple times in a row at a frequency of about 50 kHz (frequency corresponding to a period from time t₂₀ to time t₂₆).

In this way, in the initial filling process, the bubble removal flushing (step S250) is performed before the color mixture prevention flushing (step S260 in FIG. 18). Because the color mixture prevention flushing is desirably performed in a state where ink droplets are discharged from all the nozzles 15, by suppressing occurrence of dot omission through the previous bubble removal flushing, it is possible to effectively perform color mixture prevention flushing.

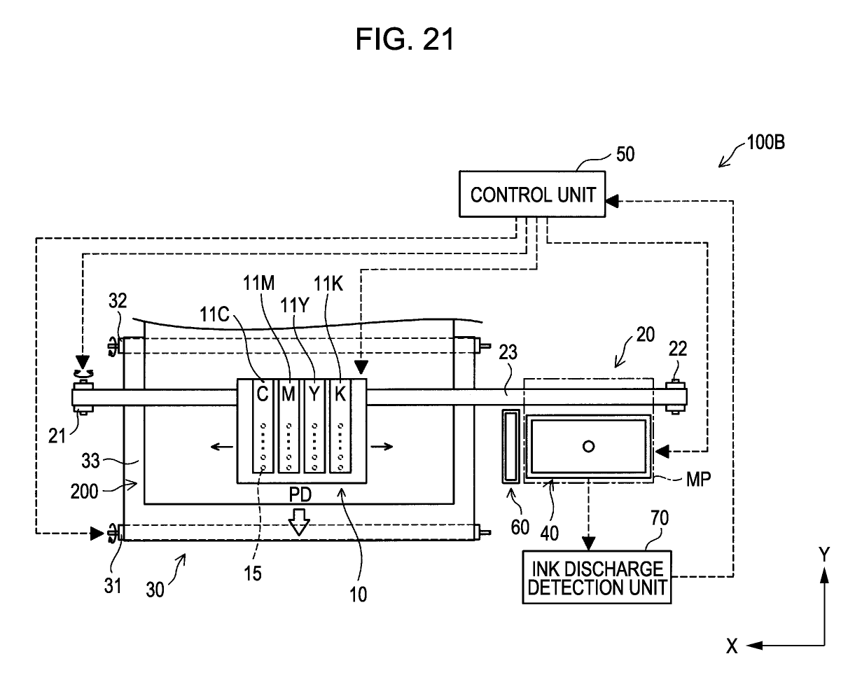

FIG. 21 is a schematic view that shows the configuration of an ink jet printer 100B according to another exemplary embodiment of the invention. FIG. 21 shows substantially the same as that of FIG. 14 except that an ink discharge detection unit 70 is provided for detecting discharge of ink from the nozzles 15. The ink discharge detection unit 70 receives an output signal from a sensor provided on the cap unit 40 and transmits a detected result to the control unit 50.

The ink discharge detection unit 70 may be, for example, configured to electrically detect discharge of ink. Specifically, when the print head unit 10 is placed at the maintenance position MP, ink is discharged in a state where electric charge is applied between the nozzle face 15p and the cap body 41 of the cap unit 40 in order to detect a variation in the amount of electric charge by the sensor. As the amount of ink discharged is small, a variation in the amount of electric charge is smaller than a predetermined value, so that it may be determined that dot omission is occurring in this case. Note that the ink discharge detection unit 70 may be configured to detect discharged ink droplets by an optical sensor or may be configured to perform detection through another method.

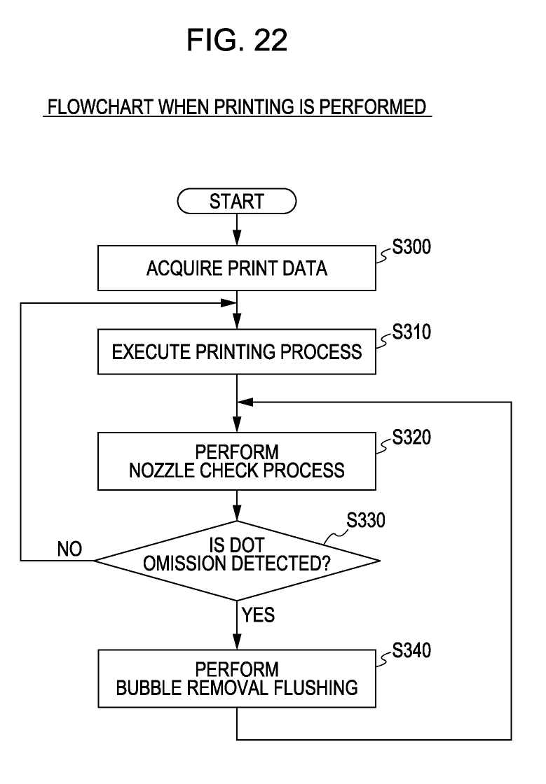

FIG. 22 is a flowchart that shows the steps performed by the control unit 50 when printing is being performed. The control unit 50, when receiving print data together with print executive instruction from an external computer, or the like, in step S300, drives the print head unit 10, the head driving unit 20, and the paper transport unit 30 in accordance with the print data in order to perform printing process in step S310.

The control unit 50, after a predetermined time has elapsed from the initiation of printing, temporarily interrupts the printing process, moves the print head unit 10 to the maintenance position MP, and then performs nozzle checking by discharging ink droplets from all the nozzles 15 (step S320). At this time, when it is detected that normal ink droplets are discharged from all the nozzles, that is, when no dot omission is detected (step S330), the control unit 50 continues to perform printing process (step S310).

On the other hand, in step S330, when the ink discharge detection unit 70 detects dot omission (step S330), the control unit 50 performs bubble removal flushing (step S340). Note that the bubble removal flushing is performed as in the same manner as described with reference to FIG. 3 and FIG. 6.

After the bubble removal flushing is performed, the control unit 50 performs nozzle checking process again (step S320) to verify performance recovery of the ink jet printer 100B. The control unit 50 repeatedly performs bubble removal flushing (step S340) until dot omission is eliminated.

According to the ink jet printer 100B, when dot omission is detected during printing, bubble removal flushing is performed to eliminate dot omission, so that it is possible to improve print quality.

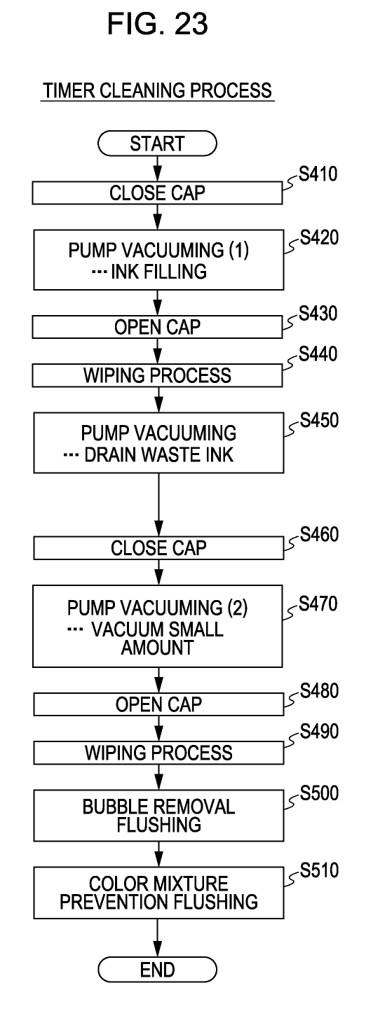

FIG. 23 is a flowchart that shows the steps of timer cleaning process among maintenance processes performed by the ink jet printer according to another exemplary embodiment of the invention. The “timer cleaning process” is a process of cleaning nozzles for recovering the performance of nozzles and is periodically performed by the control unit when the ink jet printer is not performing printing process. Note that the configuration of the ink jet printer is the same as that of the ink jet printer 100B as described with reference to FIG. 21.

The processes of step S410 to step S450 shown in FIG. 23 are performed as in the same manner as those of the first filling process (step S110 to step S150) described with reference to FIG. 18. In addition, the following processes of step S460 to step S490 are performed as in the same manner as those of the small amount filling process (step S210 to step S240) shown in FIG. 18. However, vacuuming time and vacuuming amount by the pump 43 are different from those of the initial filling process shown in FIG. 18.

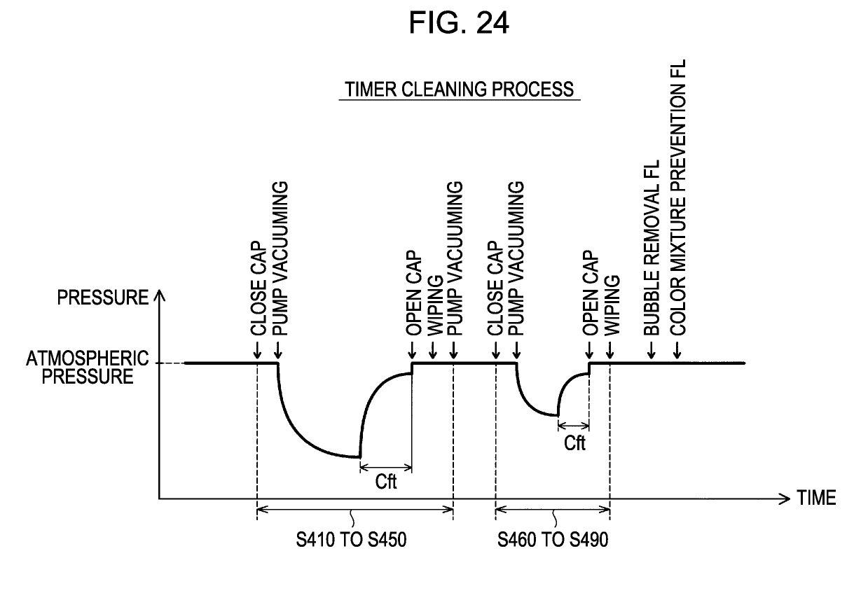

FIG. 24 is a graph that shows a change in pressure over time in the cap closed space CS in the timer cleaning process. FIG. 24 shows substantially the same as that of FIG. 19 except that the number of portions that indicate a negative pressure by vacuuming operation of the pump 43 is smaller by one.

Note that in the timer cleaning process as well, bubble removal flushing (step S510) is performed before color mixture prevention flushing (step S500). Thus, as explained before, it is possible to effectively perform color mixture prevention flushing.

In this way, by performing the timer cleaning process, it is possible to suppress dot omission and ink clogging of the nozzles 15 in order to improve the print quality of the ink jet printer.

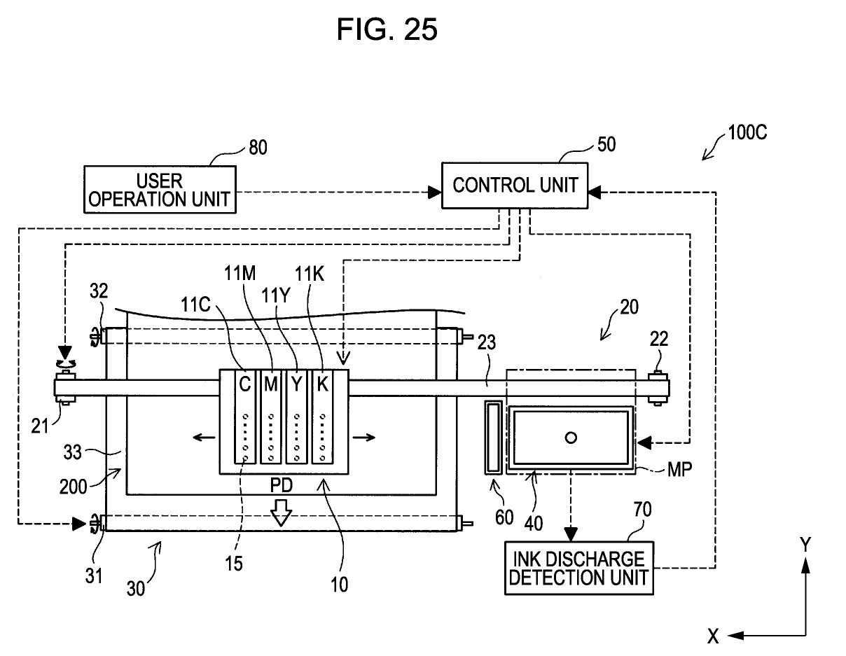

FIG. 25 is a schematic view that shows the configuration of an ink jet printer 100C according to another exemplary embodiment of the invention. FIG. 25 is substantially the same as that of FIG. 21 except that a user operation unit 80 is provided.

The user operation unit 80 is, for example, provided in the body of the ink jet printer 100C as a touch panel or an operating button. The user is able to issue an executive instruction of a process to the control unit 50 of the ink jet printer 100C through the user operation unit 80.

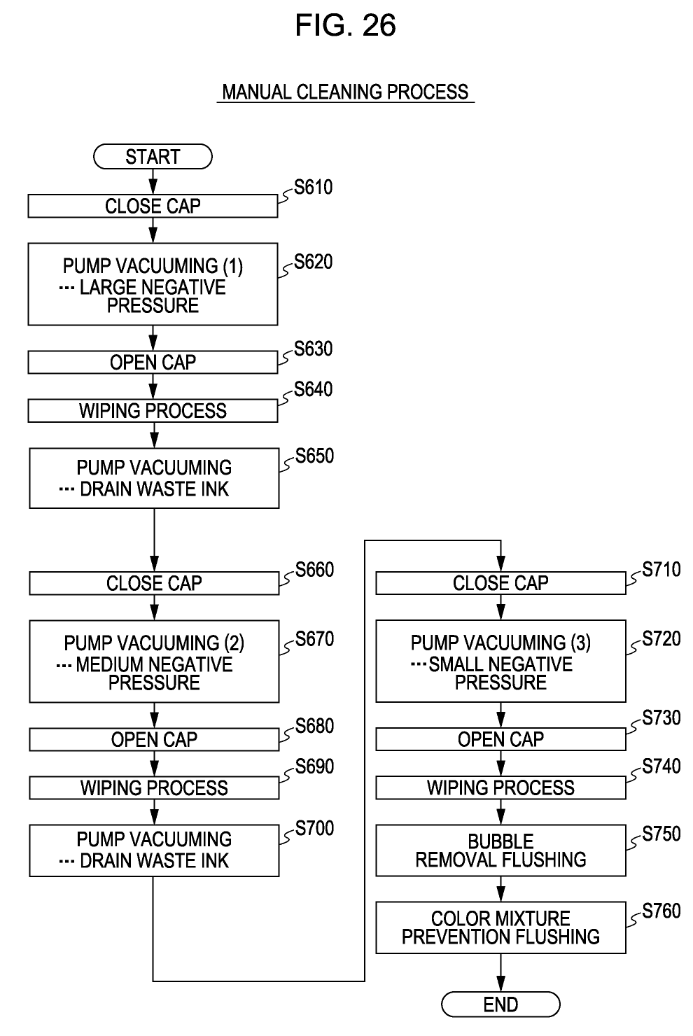

FIG. 26 is a flowchart that shows the steps of manual cleaning process among the maintenance processes performed in the ink jet printer 100C. The “manual cleaning process” is a cleaning process for recovering the performance of nozzles and is performed by the control unit 50 when the user issues instruction through the user operation unit 80 when the ink jet printer 100C is not performing printing process.

In step S610 to step S650 shown in FIG. 26, the same processes as those of the first filling process (step S110 to step S150) shown in FIG. 18 are performed. In the following step S660 to step S700, the same processes as those of step S610 to step S650 are repeatedly performed. In step S710 to step S740, the same processes as those of step S610 to step S640 are performed. That is, in the manual cleaning process, ink vacuuming process is performed three successive times in a row. However, in the manual cleaning process, the amount of ink vacuumed is gradually reduced for each ink vacuuming process.

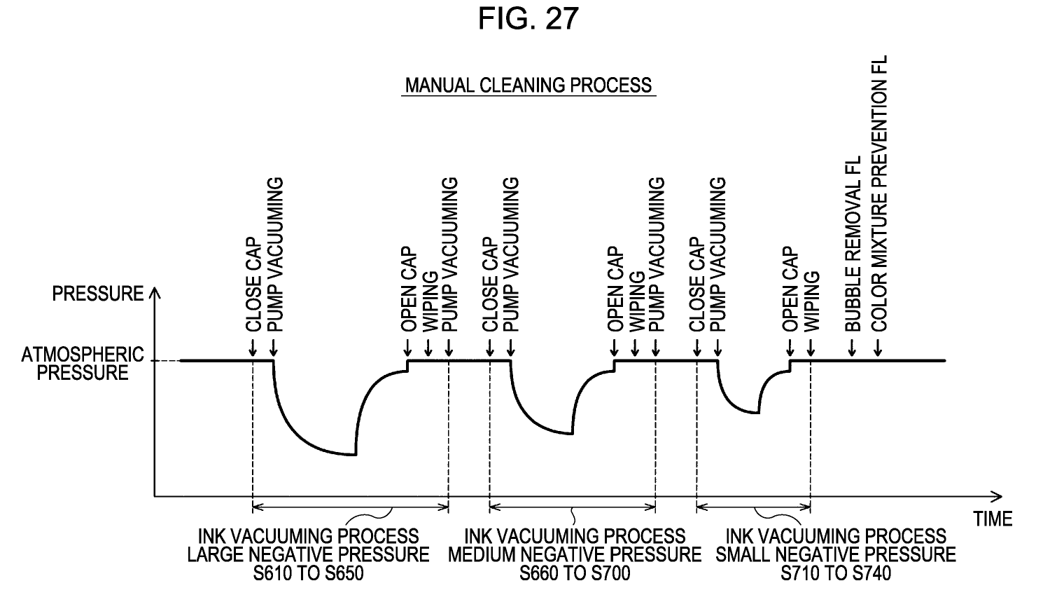

FIG. 27 is a graph that shows a change in pressure over time near the nozzles 15 in the manual cleaning process. FIG. 27 shows substantially the same as that of FIG. 19 except that a negative pressure level is varied for each ink vacuuming process. In this way, by reducing the ink vacuuming amount while performing ink vacuuming process multiple times, it is possible to suppress the amount of ink used in the cleaning process while effectively performing nozzle cleaning process.

After performing ink vacuuming process three times, the control unit 50 performs bubble removal flushing (step S750 to step S760) before color mixture prevention flushing as in the case of the initial filling process as described with reference to FIG. 18. That is, even in the manual cleaning process as well, it is possible to suppress occurrence of dot omission through bubble removal flushing, while effectively performing color mixture prevention flushing.

According to the ink jet printer 100C, by performing the nozzle cleaning process in response to user's arbitrary request, it is possible to improve the print quality.

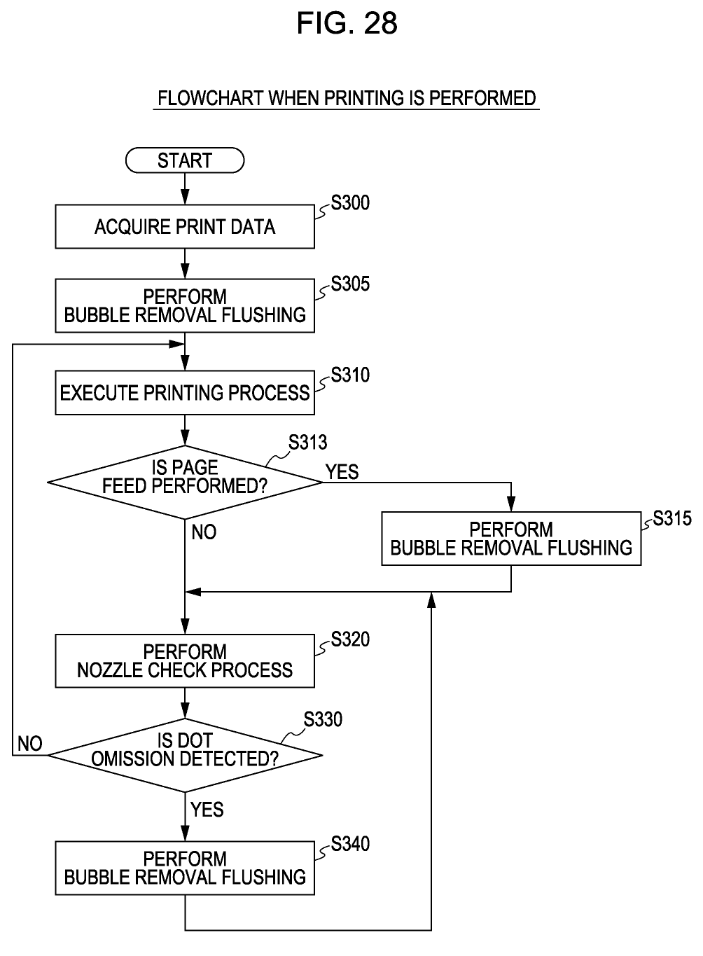

FIG. 28 is a flowchart that shows the steps performed by the control unit when printing is performed by the ink jet printer according to another exemplary embodiment of the invention. FIG. 28 is substantially the same as those of the steps (FIG. 22) performed by the control unit 50 when printing is performed except that step S305 and step S313 to step S315 are added. Note that the configuration of the ink jet printer of this embodiment is the same as that of the ink jet printer 100B as described with reference to (FIG. 21).

The control unit 50, when receiving print data together with print executive instruction from an external computer, or the like, in step S300, moves the print head unit 10 to the maintenance position MP to perform bubble removal flushing (step S305) before initiation of printing process. In addition, during printing, when page feed is performed for continuously performing printing on a new sheet (step S313), the print head unit 10 is moved again to the maintenance position MP to perform bubble removal flushing (step S315). Furthermore, when the ink discharge detection unit 70 detects dot omission, bubble removal flushing is performed (step S320 to step S340).

According to the steps when printing is performed, because bubble removal flushing is definitely performed at a predetermined timing, it is possible to reduce occurrence of potential dot omission and furthermore it is possible to improve print quality. Note that the aspects of the invention are not limited to the embodiments or embodiment described above, but they may be modified into various alternative example embodiments without departing from the scope of the appended claims.

In the above exemplary embodiments, the ink jet printer is described; instead, the aspects of the invention may also be applied to a fluid ejecting apparatus that discharges other fluid (liquid).

In the above exemplary embodiments, the piezoelectric element 17 is minutely vibrated by the vibrating drive pulse 301 in interval step of bubble removal flushing; instead, the vibrating drive pulse 301 may be a drive pulse having another shape or may be omitted.

In the above exemplary embodiments, ink droplets are idly discharged 2000 times as successive flushing set (FIG. 3); instead, ink droplets may be idly discharged selected number of times. In addition, in each successive flushing set, the bubble removal drive pulse 300 is generated continuously with the same period; instead, it may be generated with a changed period.

In the above exemplary embodiments, the width of the intermediate pulse portion Pwh of the bubble removal drive pulse 300 (FIG. 6) is varied for each successive flushing set; instead, successive flushing set may be repeated with the same width of the intermediate pulse portion Pwh.

In the above exemplary embodiments, each successive flushing set is formed of a plurality of bubble removal drive pulses 300 having the same waveform; instead, the successive flushing sets may include respective drive pulses of which at least portion of waveform is different from one another. For example, each successive flushing set may include, in addition to the bubble removal drive pulse 300, a bubble removal drive pulse 300 having a different width of the intermediate pulse portion Pwh or a bubble removal drive pulse 300 having a different voltage value Vh.

In the above exemplary embodiments, when the ink discharge detection unit 70 detects dot omission, bubble removal flushing is performed (step S330 to step S340 in FIG. 22); instead, another maintenance process may be performed together with bubble removal flushing. For example, color mixture prevention flushing may be performed subsequently.

In the above exemplary embodiments, the user operation unit 80 is provided in the body of the ink jet printer 100C; instead, it may be implemented through a program executed on an external computer connected to the ink jet printer 100C.

In the above exemplary embodiments, the width of the second pulse portion Pwd is larger than or equal to half the natural period of the piezoelectric element 17; instead, the width of the second pulse portion Pwd may be smaller than half the natural period of the piezoelectric element 17. However, with the configuration of the above example embodiments, it is possible to further effectively remove a bubble in the pressure chamber 13.

In the above exemplary embodiments, the bubble removal drive pulse 300 includes the intermediate pulse portion Pwh; instead, the intermediate pulse portion Pwh may be omitted or may be shorter than 0.7 times the Helmholtz resonance period Tc. In addition, the width of the intermediate pulse portion Pwh may be longer than the Helmholtz resonance period Tc. However, with the configuration of the above embodiments, it is possible to further effectively remove a bubble in the pressure chamber 13.

What is claimed is:

1. A system for ejecting liquid, the system comprising:
a pressure chamber configured to contain a liquid and having a nozzle configured to eject the liquid;
a pressure generating element coupled to the pressure chamber and configured to apply a pressure to the pressure chamber and the liquid filled in the pressure chamber in response to a bubble removal drive pulse, and
a control unit configured to generate the bubble removal drive pulse, wherein by controlling a voltage level, a pulse width and a sequence of the bubble removal drive pulse, a portion of the liquid along with a portion of bubbles inside the liquid are ejected from the nozzle.

2. The system of claim 1 wherein the control unit is further configured to generate a vibrating drive pulse having a voltage level, wherein the voltage level of the bubble removal drive pulse is higher than the voltage level of the vibrating drive pulse.

3. The system of claim 2, wherein the vibrating drive pulse is configured to vibrate the liquid inside the pressure chamber up to a level that the liquid is not discharged from the nozzle.

4. The system of claim 1, wherein the bubble removal drive pulse comprises:
a first pulse portion having a width and configured to expand the pressure chamber into an expanded state via the pressure generating element;
a second pulse portion having a width and configured to contract the pressure chamber from an expanded state via the pressure generating element, and
an intermediate pulse portion having a width and located between the first pulse portion and the second pulse portion, wherein the intermediate pulse portion is configured to hold the expanded state of the pressure chamber for a predetermined amount of time via the pressure generating element.

5. The system of claim 4, wherein the width of the intermediate pulse portion is at least 0.7 times the Helmholtz resonance period of the liquid inside the pressure chamber.

6. The system of claim 4, wherein the width of the intermediate pulse portion is equal to or smaller than the Helmholtz resonance period of the liquid inside the pressure chamber.

7. The system of claim 4, wherein the width of the first pulse portion is smaller or equal to half the Helmholtz resonance period of the liquid filled in the pressure chamber.

8. The system of claim 4, wherein a sequence of a drive pulse causes vibration of the liquid inside the pressure chamber.

9. The system of claim 4, wherein the first pulse portion causes a negative pressure inside the pressure chamber.

10. The system of claim 9, wherein the negative pressure causes an increase in a diameter of a portion of the bubbles.

11. The system of claim 4, wherein the width of the second pulse portion is equal or larger than half a natural vibration period of the pressure generating element.

12. A method for ejecting liquid from a pressure chamber having a nozzle and a pressure generating element coupled to the pressure chamber, the method comprising:
using a control unit, generating a bubble removal drive pulse having a first pulse portion, an intermediate pulse portion and a second pulse portion each having a width, and driving the pressure generating element to apply a pressure to the liquid inside the pressure chamber, and
using the pressure generating element, ejecting liquid from the pressure chamber through the nozzle.

13. The method of claim 12 further comprising:
using the control unit, generating a vibrating drive pulse having a voltage level, wherein the voltage level of the bubble removal drive pulse is higher than the voltage level of the vibrating drive pulse.

14. The method of claim 12, wherein the vibrating drive pulse is configured to vibrate the liquid inside the pressure chamber up to a level that the liquid is not discharged from the nozzle.

15. The method of claim 12 further comprising:
expanding the pressure chamber into an expanded state via the first pulse portion;
keeping the pressure chamber into an expanded state via the intermediate pulse portion, wherein the pressure chamber remains in the expanded state for duration of the intermediate pulse, and
contracting the pressure chamber from the expanded state via the second pulse portion.

16. The method of claim 12 wherein the width of the intermediate pulse portion is at least 0.7 times the Helmholtz resonance period of the liquid inside the pressure chamber.

17. The method of claim 12, wherein the width of the intermediate pulse portion is equal to or smaller than the Helmholtz resonance period of the liquid inside the pressure chamber.

18. The method of claim 12, wherein the width of the first pulse portion is smaller or equal to half the Helmholtz resonance period of the liquid filled in the pressure chamber.

19. The method of claim 12, wherein the first pulse portion causes a negative pressure inside the pressure chamber.

20. The method of claim 12, wherein the negative pressure causes an increase in a diameter of a bubble inside the liquid.
